(19) United States
(12) Patent Application Publication
(10) Pub. No.: US 2025/0300763 A1
(43) Pub. Date: Sep. 25, 2025

(54) TWO-STAGE PEELING FOR PROBABILISTIC SHAPING

(71) Applicant: QUALCOMM Incorporated, San Diego, CA (US)

(72) Inventors: Wei LIU, Beijing (CN); Thomas Joseph RICHARDSON, South Orange, NJ (US); Liangming WU, Beijing (CN); Changlong XU, Beijing (CN); Ori SHENTAL, Marlboro, NJ (US); Hao XU, Beijing (CN)

(21) Appl. No.: 18/869,610

(22) PCT Filed: Aug. 6, 2022
(86) PCT No.: PCT/CN2022/110728

§ 371 Date: Nov. 26, 2024

(51) Int. Cl. H04L 1/00

(52) U.S. Cl. CPC H04L 1/0042

(57) ABSTRACT

Methods, systems, and devices for wireless communications are described. A device may obtain information bits and perform a two-stage encoding operation using the information bits. As part of the two-stage encoding procedure, the device may determine an interval corresponding to an energy threshold for a set of symbol sequences. In a first stage of the two-stage encoding operation, the device may determine a composition of a symbol sequence of the set of symbol sequences based on the information bits. In a second stage of the two-stage encoding operation, the device may generate the symbol sequence based on the information bits and the composition. The device may transmit the symbol sequence to another device using a wireless medium.

### CROSS REFERENCE

The present Application is a 371 national phase filing of International PCT Application No. PCT/CN2022/110728 by LIU et al., entitled “TWO-STAGE PEELING FOR PROBABILISTIC SHAPING,” filed Aug. 6, 2022, which is assigned to the assignee hereof, and which is expressly incorporated by reference in its entirety herein.

### FIELD OF TECHNOLOGY

The following relates to wireless communications, including techniques for two-stage peeling for probabilistic shaping.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations, each supporting wireless communication for communication devices, which may be known as user equipment (UE). In some cases, the network entities, or the UE, or both, may use a modulation and coding scheme (MCS) to improved data transfer reliability within the communications system.

### SUMMARY

The described techniques relate to improved methods, systems, devices, and apparatuses that support techniques for two-stage peeling for probabilistic shaping. For example, the described techniques provide a framework for achieving sphere shaping using two-stage encoding of direct peeling. In some examples, a device may obtain multiple information bits and perform a two-stage encoding operation using the multiple information bits. As part of the two-stage encoding procedure, the device may determine an interval corresponding to an energy threshold for a set of symbol sequences. Each symbol sequence of the set of symbol sequences may be of a same length. In a first stage of the two-stage encoding operation, the device may determine a composition of a symbol sequence of the set of symbol sequences based on the multiple information bits.

In some examples, a first element of the composition may be determined in a first iteration of the first stage of the two-stage encoding operation based on selecting a first transition associated with a first transition probability. The first element of the composition may correspond to a quantity of occurrences of a first symbol of an alphabet of symbols used for generating the symbol sequence. In some examples, a first subinterval of the interval may be determined, such that the first subinterval corresponds to the first transition. Additionally, or alternatively, a second element of the composition may be determined as part of a second iteration of the first stage of the two-stage encoding operation based on selecting a second transition associated with a second transition probability. The second element of the composition may correspond to a quantity of occurrences of a second symbol of the alphabet of symbols used for generating the symbol sequence. A second subinterval of the interval may be determined, such that the second subinterval corresponds to the second transition. In some examples, in a second stage of the two-stage encoding operation, the device may generate the symbol sequence based on the multiple information bits and the composition. An energy of the symbol sequence may be less than or equal to the energy threshold. The device may transmit the symbol sequence to another device using a wireless medium.

A method for wireless communication at a first device is described. The method may include obtaining a set of multiple information bits, performing a two-stage encoding operation using the set of multiple information bits, the two-stage encoding operation including, determining an interval corresponding to an energy threshold for a set of symbol sequences, each symbol sequence of the set of symbol sequences being of a same length, determining, in a first stage of the two-stage encoding operation, a composition of a symbol sequence of the set of symbol sequences based on the set of multiple information bits, where, a first element of the composition is determined in a first iteration of the first stage of the two-stage encoding operation based on selecting a first transition associated with a first transition probability, the first element of the composition corresponding to a quantity of occurrences of a first symbol of an alphabet of symbols used for generating the symbol sequence, a first subinterval of the interval is determined, the first subinterval corresponding to the first transition, a second element of the composition is determined in a second iteration of the first stage of the two-stage encoding operation based on selecting a second transition associated with a second transition probability, the second element of the composition corresponding to a quantity of occurrences of a second symbol of the alphabet of symbols used for generating the symbol sequence, a second subinterval of the interval is determined, the second subinterval corresponding to the second transition, generating, in a second stage of the two-stage encoding operation, the symbol sequence based on the set of multiple information bits and the composition, where an energy of the symbol sequence is less than or equal to the energy threshold, and transmitting the symbol sequence to a second device using a wireless medium.

An apparatus for wireless communication at a first device is described. The apparatus may include a processor, memory coupled with the processor, and instructions stored in the memory. The instructions may be executable by the processor to cause the apparatus to obtain a set of multiple information bits, perform a two-stage encoding operation using the set of multiple information bits, the two-stage encoding operation including, determine an interval corresponding to an energy threshold for a set of symbol sequences, each symbol sequence of the set of symbol sequences being of a same length, determine, in a first stage of the two-stage encoding operation, a composition of a symbol sequence of the set of symbol sequences based on the set of multiple information bits, where, a first element of the composition be determined in a first iteration of the first stage of the two-stage encoding operation based on selecting a first transition associated with a first transition probability, the first element of the composition corresponding to a quantity of occurrences of a first symbol of an alphabet of symbols used for generating the symbol sequence, a first subinterval of the interval be determined, the first subinterval corresponding to the first transition, a second element of the composition be determined in a second iteration of the first stage of the two-stage encoding operation based on selecting a second transition associated with a second transition probability, the second element of the composition corresponding to a quantity of occurrences of a second symbol of the alphabet of symbols used for generating the symbol sequence, a second subinterval of the interval be determined, the second subinterval corresponding to the second transition, generate, in a second stage of the two-stage encoding operation, the symbol sequence based on the set of multiple information bits and the composition, where an energy of the symbol sequence is less than or equal to the energy threshold, and transmit the symbol sequence to a second device using a wireless medium.

Another apparatus for wireless communication at a first device is described. The apparatus may include means for obtaining a set of multiple information bits, means for performing a two-stage encoding operation using the set of multiple information bits, the two-stage encoding operation including, means for determining an interval corresponding to an energy threshold for a set of symbol sequences, each symbol sequence of the set of symbol sequences being of a same length, means for determining, in a first stage of the two-stage encoding operation, a composition of a symbol sequence of the set of symbol sequences based on the set of multiple information bits, where, means for a first element of the composition is determined in a first iteration of the first stage of the two-stage encoding operation based on selecting a first transition associated with a first transition probability, the first element of the composition corresponding to a quantity of occurrences of a first symbol of an alphabet of symbols used for generating the symbol sequence, means for a first subinterval of the interval is determined, the first subinterval corresponding to the first transition, means for a second element of the composition is determined in a second iteration of the first stage of the two-stage encoding operation based on selecting a second transition associated with a second transition probability, the second element of the composition corresponding to a quantity of occurrences of a second symbol of the alphabet of symbols used for generating the symbol sequence, means for a second subinterval of the interval is determined, the second subinterval corresponding to the second transition, means for generating, in a second stage of the two-stage encoding operation, the symbol sequence based on the set of multiple information bits and the composition, where an energy of the symbol sequence is less than or equal to the energy threshold, and means for transmitting the symbol sequence to a second device using a wireless medium.

A non-transitory computer-readable medium storing code for wireless communication at a first device is described. The code may include instructions executable by a processor to obtain a set of multiple information bits, perform a two-stage encoding operation using the set of multiple information bits, the two-stage encoding operation including, determine an interval corresponding to an energy threshold for a set of symbol sequences, each symbol sequence of the set of symbol sequences being of a same length, determine, in a first stage of the two-stage encoding operation, a composition of a symbol sequence of the set of symbol sequences based on the set of multiple information bits, where, a first element of the composition be determined in a first iteration of the first stage of the two-stage encoding operation based on selecting a first transition associated with a first transition probability, the first element of the composition corresponding to a quantity of occurrences of a first symbol of an alphabet of symbols used for generating the symbol sequence, a first subinterval of the interval be determined, the first subinterval corresponding to the first transition, a second element of the composition be determined in a second iteration of the first stage of the two-stage encoding operation based on selecting a second transition associated with a second transition probability, the second element of the composition corresponding to a quantity of occurrences of a second symbol of the alphabet of symbols used for generating the symbol sequence, a second subinterval of the interval be determined, the second subinterval corresponding to the second transition, generate, in a second stage of the two-stage encoding operation, the symbol sequence based on the set of multiple information bits and the composition, where an energy of the symbol sequence is less than or equal to the energy threshold, and transmit the symbol sequence to a second device using a wireless medium.

In some examples of the method, apparatuses, and non-transitory computer-readable medium described herein, determining the composition of the symbol sequence may include operations, features, means, or instructions for determining a first number based on the set of multiple information bits and the energy threshold, identifying a first set of nonnegative integers, where each integer includes a first candidate element associated with the first element of the composition, determining a first set of multiple cumulative sequence quantities, where, a first cumulative sequence quantity of the first set of multiple cumulative sequence quantities corresponds to a first cardinality of a respective first set of sequences of a first set of multiple sets of sequences generated using a first portion of the alphabet of symbols, a first length of each sequence of the respective first set of sequences of the first set of multiple sets of sequences corresponds to a first difference between a length of the symbol sequence and a first nonnegative integer of the first set of nonnegative integers, a first energy of each sequence of the respective first set of sequences of the first set of multiple sets of sequences may be less than or equal to a second difference between the energy threshold and a product of the first nonnegative integer of the first set of nonnegative integers and an energy of the first symbol, determining a first set of multiple binomial coefficients, determining a first set of multiple transition probabilities based at least on the first set of multiple cumulative sequence quantities and the first set of multiple binomial coefficients, identifying that the first number corresponds to the first transition probability from the first set of multiple transition probabilities, where determining the first element of the composition may be based on the identifying, and performing a first scaling operation on the first number based on determining the first element of the composition and the first set of multiple transition probabilities, where a second number may be generated based on the first scaling operation.

Some examples of the method, apparatuses, and non-transitory computer-readable medium described herein may further include operations, features, means, or instructions for determining a residual length, the residual length being equal to a difference between the length of the symbol sequence and the first element of the composition and determining a residual energy, the residual energy being equal to a difference between the energy threshold and a product of the first element of the composition and the energy of the first symbol.

Some examples of the method, apparatuses, and non-transitory computer-readable medium described herein may further include operations, features, means, or instructions for identifying a second set of nonnegative integers, where each nonnegative integer of the second set of nonnegative integers includes a second candidate element associated with the second element of the composition, determining a second set of multiple cumulative sequence quantities, where, a second cumulative sequence quantity of the second set of multiple cumulative sequence quantities corresponds to a second cardinality of a respective second set of sequences of a second set of multiple sets of sequences generated using a second portion of the alphabet of symbol sequences, a second length of each sequence of the respective second set of sequences of the second set of multiple sets of sequences corresponds to a third difference between the residual length and a second nonnegative integer of the second set of nonnegative integers, a second energy of each sequence of the respective second set of sequences of the second set of multiple sets of sequences may be less than or equal to a fourth difference between the residual energy and a product of the second nonnegative integer and an energy of the second symbol, determining a second set of multiple binomial coefficients, determining a second set of multiple transition probabilities based at least on the second set of multiple cumulative sequence quantities and the second set of multiple binomial coefficients, identifying that the second number corresponds to the second transition probability from the second set of multiple transition probabilities, where determining the second element of the composition may be based on the identifying, and performing a second scaling operation on the second number based on determining the second element of the composition and the second set of multiple transition probabilities, where a third number may be generated based on the second scaling operation.

In some examples of the method, apparatuses, and non-transitory computer-readable medium described herein, each transition probability of the second set of multiple transition probabilities corresponds to a respective nonnegative integer of the second set of nonnegative integers and the second set of multiple transition probabilities includes a first quantity of transition probabilities equal to a second quantity of nonnegative integers included in the second set of nonnegative integers.

In some examples of the method, apparatuses, and non-transitory computer-readable medium described herein, each transition probability of the first set of multiple transition probabilities corresponds to a respective nonnegative integer of the first set of nonnegative integers and the first set of multiple transition probabilities includes a first quantity of transition probabilities equal to a second quantity of nonnegative integers included in the first set of nonnegative integers.

Some examples of the method, apparatuses, and non-transitory computer-readable medium described herein may further include operations, features, means, or instructions for partitioning the interval into a first set of multiple subintervals in the first iteration of the first stage of the two-stage encoding operation based on the first set of multiple transition probabilities, where a respective length of each subinterval of the first set of multiple subintervals may be proportional to a respective transition probability of the first set of multiple transition probabilities, identifying the first subinterval based on the first number and the first set of multiple subintervals, and performing a scaling operation on the first subinterval based on the identifying.

Some examples of the method, apparatuses, and non-transitory computer-readable medium described herein may further include operations, features, means, or instructions for partitioning the first subinterval in the second iteration of the first stage of the two-stage encoding operation into a second set of multiple subintervals, where a respective length of each subinterval of the second set of multiple subintervals may be proportional to a respective transition probability of a second set of multiple transition probabilities and identifying the second subinterval based on the second number and the second set of multiple subintervals.

In some examples of the method, apparatuses, and non-transitory computer-readable medium described herein, the two-stage encoding operation includes amplitude shaping and the first symbol and the second symbol each include an amplitude symbol.

In some examples of the method, apparatuses, and non-transitory computer-readable medium described herein, the first stage includes a set of multiple iterations including at least the first iteration and the second iteration and the set of multiple iterations may be based on a cardinality of the alphabet.

In some examples of the method, apparatuses, and non-transitory computer-readable medium described herein, the composition includes a set of multiple elements including at least the first element and the second element and the set of multiple elements may be based on a cardinality of the alphabet.

In some examples of the method, apparatuses, and non-transitory computer-readable medium described herein, each element of the set of multiple elements includes a nonnegative integer.

In some examples of the method, apparatuses, and non-transitory computer-readable medium described herein, the first subinterval corresponds to a first subset of symbol sequences of the set of symbol sequences and the second subinterval corresponds to a second subset of symbol sequences of the first subset of symbol sequences.

In some examples of the method, apparatuses, and non-transitory computer-readable medium described herein, the first element of the composition determined in the first iteration corresponds to a same quantity of occurrences of the first symbol of the alphabet of symbols within each symbol sequence of the first subset of symbol sequences and the second element of the composition determined in the second iteration corresponds to a same quantity of occurrences of the second symbol of the alphabet of symbols within each symbol sequence of the second subset of symbol sequences.

A method for wireless communication at a second device is described. The method may include obtaining a symbol sequence from a first device, performing a two-stage decoding operation using the symbol sequence, the two-stage decoding operation including, determining an interval corresponding to an energy threshold for a set of symbol sequences, where the set of symbol sequences includes the symbol sequence, and where each symbol sequence of the set of symbol sequences is of a same length, determining, in a first stage of the two-stage decoding operation, a composition of the symbol sequence, where, a first element of the composition is determined in a first iteration of the first stage of the two-stage decoding operation based on a first quantity of occurrences of a first symbol of an alphabet of symbols used for generating the symbol sequence, a first subinterval of the interval is determined based on determining the first element of the composition and a first set of multiple transition probabilities, a second element of the composition is determined in a second iteration of the first stage of the two-stage decoding operation based on a second quantity of occurrences of a second symbol of the alphabet of symbols used for generating the symbol sequence, a second subinterval of the interval is determined based on determining the second element of the composition and a second set of multiple transition probabilities, and estimating, in a second stage of the two-stage decoding operation, a bit sequence based on the symbol sequence, the composition, and the second subinterval or one or more other subintervals subsequent to the second subinterval.

An apparatus for wireless communication at a second device is described. The apparatus may include a processor, memory coupled with the processor, and instructions stored in the memory. The instructions may be executable by the processor to cause the apparatus to obtain a symbol sequence from a first device, perform a two-stage decoding operation using the symbol sequence, the two-stage decoding operation including, determine an interval corresponding to an energy threshold for a set of symbol sequences, where the set of symbol sequences includes the symbol sequence, and where each symbol sequence of the set of symbol sequences is of a same length, determine, in a first stage of the two-stage decoding operation, a composition of the symbol sequence, where, a first element of the composition be determined in a first iteration of the first stage of the two-stage decoding operation based on a first quantity of occurrences of a first symbol of an alphabet of symbols used for generating the symbol sequence, a first subinterval of the interval be determined based on determining the first element of the composition and a first set of multiple transition probabilities, a second element of the composition be determined in a second iteration of the first stage of the two-stage decoding operation based on a second quantity of occurrences of a second symbol of the alphabet of symbols used for generating the symbol sequence, a second subinterval of the interval be determined based on determining the second element of the composition and a second set of multiple transition probabilities, and estimate, in a second stage of the two-stage decoding operation, a bit sequence based on the symbol sequence, the composition, and the second subinterval or one or more other subintervals subsequent to the second subinterval.

Another apparatus for wireless communication at a second device is described. The apparatus may include means for obtaining a symbol sequence from a first device, means for performing a two-stage decoding operation using the symbol sequence, the two-stage decoding operation including, means for determining an interval corresponding to an energy threshold for a set of symbol sequences, where the set of symbol sequences includes the symbol sequence, and where each symbol sequence of the set of symbol sequences is of a same length, means for determining, in a first stage of the two-stage decoding operation, a composition of the symbol sequence, where, means for a first element of the composition is determined in a first iteration of the first stage of the two-stage decoding operation based on a first quantity of occurrences of a first symbol of an alphabet of symbols used for generating the symbol sequence, means for a first subinterval of the interval is determined based on determining the first element of the composition and a first set of multiple transition probabilities, means for a second element of the composition is determined in a second iteration of the first stage of the two-stage decoding operation based on a second quantity of occurrences of a second symbol of the alphabet of symbols used for generating the symbol sequence, means for a second subinterval of the interval is determined based on determining the second element of the composition and a second set of multiple transition probabilities, and means for estimating, in a second stage of the two-stage decoding operation, a bit sequence based on the symbol sequence, the composition, and the second subinterval or one or more other subintervals subsequent to the second subinterval.

A non-transitory computer-readable medium storing code for wireless communication at a second device is described. The code may include instructions executable by a processor to obtain a symbol sequence from a first device, perform a two-stage decoding operation using the symbol sequence, the two-stage decoding operation including, determine an interval corresponding to an energy threshold for a set of symbol sequences, where the set of symbol sequences includes the symbol sequence, and where each symbol sequence of the set of symbol sequences is of a same length, determine, in a first stage of the two-stage decoding operation, a composition of the symbol sequence, where, a first element of the composition be determined in a first iteration of the first stage of the two-stage decoding operation based on a first quantity of occurrences of a first symbol of an alphabet of symbols used for generating the symbol sequence, a first subinterval of the interval be determined based on determining the first element of the composition and a first set of multiple transition probabilities, a second element of the composition be determined in a second iteration of the first stage of the two-stage decoding operation based on a second quantity of occurrences of a second symbol of the alphabet of symbols used for generating the symbol sequence, a second subinterval of the interval be determined based on determining the second element of the composition and a second set of multiple transition probabilities, and estimate, in a second stage of the two-stage decoding operation, a bit sequence based on the symbol sequence, the composition, and the second subinterval or one or more other subintervals subsequent to the second subinterval.

In some examples of the method, apparatuses, and non-transitory computer-readable medium described herein, determining the composition of the symbol sequence may include operations, features, means, or instructions for identifying a first set of nonnegative integers, where each integer of the first set of nonnegative integers may be less than or equal to the first element of the composition, determining a first set of multiple cumulative sequence quantities, where, a first cumulative sequence quantity of the first set of multiple cumulative sequence quantities corresponds to a first cardinality of a respective first set of sequences of a first set of multiple sets of sequences generated using a first portion of the alphabet of symbol sequences, a first length of each sequence of the respective first set of sequences of the first set of multiple sets of sequences corresponds to a first difference between a length of the symbol sequence and a first nonnegative integer of the first set of nonnegative integers, a first energy of each sequence of the respective first set of sequences of the first set of multiple sets of sequences may be less than or equal to a second difference between the energy threshold and a product of the first nonnegative integer of the first set of nonnegative integers and an energy of the first symbol, determining a first set of multiple binomial coefficients, and determining the first set of multiple transition probabilities based at least on the first set of multiple cumulative sequence quantities and the first set of multiple binomial coefficients.

In some examples of the method, apparatuses, and non-transitory computer-readable medium described herein, each transition probability of the first set of multiple transition probabilities corresponds to a respective nonnegative integer of the first set of nonnegative integers.

In some examples of the method, apparatuses, and non-transitory computer-readable medium described herein, the first set of nonnegative integers includes the first element and a length of the first subinterval may be proportional to a transition probability corresponding to the first element of the composition.

Some examples of the method, apparatuses, and non-transitory computer-readable medium described herein may further include operations, features, means, or instructions for determining a residual length, the residual length being equal to a difference between the length of the symbol sequence and the first element of the composition and determining a residual energy, the residual energy being equal to a difference between the energy threshold and a product of the first element of the composition and the energy of the first symbol.

Some examples of the method, apparatuses, and non-transitory computer-readable medium described herein may further include operations, features, means, or instructions for identifying a second set of nonnegative integers, where each nonnegative integer of the second set of nonnegative integers may be less than or equal to the second element of the composition, determining a second set of multiple cumulative sequence quantities, where, a second cumulative sequence quantity of the second set of multiple cumulative sequence quantities corresponds to a second cardinality of a respective second set of sequences of a second set of multiple sets of sequences generated using a second portion of the alphabet of symbols, a second length of each sequence of the respective second set of sequences of the second set of multiple sets of sequences corresponds to a third difference between the residual length and a second nonnegative integer of the second set of nonnegative integers, a second energy of each sequence of the respective second set of sequences of the second set of multiple sets of sequences may be less than or equal to a fourth difference between the residual energy and a product of the second nonnegative integer and an energy of the second symbol, determining a second set of multiple binomial coefficients, and determining the second set of multiple transition probabilities based at least on the second set of multiple cumulative sequence quantities and the second set of multiple binomial coefficients.

### BRIEF DESCRIPTION OF THE DRAWINGS

FIGS. 1 and 2 each illustrate an example of a wireless communications system that supports techniques for probabilistic shaping using peeling in accordance with one or more aspects of the present disclosure.

FIG. 3 illustrates an example of a partitioning scheme that supports techniques for probabilistic shaping using peeling in accordance with one or more aspects of the present disclosure.

FIGS. 4 and 5 each illustrate an example of a process flow that supports techniques for probabilistic shaping using peeling in accordance with one or more aspects of the present disclosure.

FIGS. 6 and 7 show block diagrams of devices that support techniques for probabilistic shaping using peeling in accordance with one or more aspects of the present disclosure.

FIG. 8 shows a block diagram of a communications manager that supports techniques for probabilistic shaping using peeling in accordance with one or more aspects of the present disclosure.

FIG. 9 shows a diagram of a system including a device that supports techniques for probabilistic shaping using peeling in accordance with one or more aspects of the present disclosure.

FIGS. 10 and 11 show block diagrams of devices that support techniques for probabilistic shaping using peeling in accordance with one or more aspects of the present disclosure.

FIG. 12 shows a block diagram of a communications manager that supports techniques for probabilistic shaping using peeling in accordance with one or more aspects of the present disclosure.

FIG. 13 shows a diagram of a system including a device that supports techniques for probabilistic shaping using peeling in accordance with one or more aspects of the present disclosure.

FIGS. 14 and 15 show flowcharts illustrating methods that support techniques for probabilistic shaping using peeling in accordance with one or more aspects of the present disclosure.

### DETAILED DESCRIPTION

In some wireless communications systems, a communication device (e.g., a user equipment (UE), a network entity) may use higher-order modulation schemes (16 quadrature amplitude modulation (QAM), 64 QAM, 256 QAM, etc.) to improve the reliability, throughput, or both with which another communication device (e.g., another UE, another network entity) may recover source information of a modulated signal (e.g., modulated using the higher-order modulation scheme). As part of higher-order modulation schemes, the communication device may map a bit sequence to a symbol sequence and transmit the symbol sequence to the other communication device using a communication channel (e.g., via the modulated signal transmitted using a wireless medium). An information rate (e.g., a quantity of bits that may be transmitted per symbol of the symbol sequence) achievable using some higher-order modulation schemes may be reduced relative to a capacity of the communication channel (e.g., an achievable rate at which information may be reliably transmitted using the communication channel). A difference between the information rate achievable using a higher-order modulation scheme and the capacity of the communication channel (e.g., the channel capacity) may be referred to as a shaping gap. In some examples, to reduce the shaping gap (e.g., to achieve an information rate that approaches channel capacity), the communication device may achieve sphere shaping (e.g., as part of probabilistic amplitude shaping), in which bit sequences (e.g., sequences of information bits) may be mapped to symbol sequences with relatively low energy (e.g., relative to other possible symbol sequences to which the bit sequence may be mapped). However, some techniques for achieving sphere shaping may be complex, which may lead to increased overhead and computation costs (e.g., resource usage, time, power) at the communication device.

Various aspects of the present disclosure generally relate to techniques for probabilistic shaping using peeling, and more specifically, to a framework for achieving sphere shaping using two-stage encoding (or two-stage decoding) of direct peeling. For example, using two-stage encoding (or two-stage decoding) of direct peeling, as described herein, a communication device (e.g., a transmitting device) may map a bit sequence to a symbol sequence in an iterative manner. In some examples, the communication device may generate information bits and, in a first stage of the two-stage encoding operation using a symbol alphabet ( [symbol] ₘ={a₁, a₂, . . . , aₘ}), iteratively determine a respective composition (k*ᵢ) of each symbol (aᵢ) of the symbol alphabet ( [symbol] ₘ) within a symbol sequence(s) to be output in a second stage of the two-stage encoding operation. That is, the communication device may iteratively determine a composition k*=(k*₁, . . . , k*ₘ) of a symbol sequence (e.g., s=(s₁, s₂, . . . , sₙ)) to be generated in accordance with the symbol alphabet [symbol] ₘ={a₁, a₂, . . . , aₘ}. As described herein, the composition (k*ᵢ) of a symbol (aᵢ) may correspond to a quantity of occurrences of the symbol (aᵢ) within the symbol sequence (e.g., to be output in a second stage of the two-stage encoding operation). In some examples, the first stage of the two-stage encoding operation may include an interval refinement process, in which the communication device may partition an interval (or a subinterval) that may correspond to a set (or subset) of symbol sequences that may each correspond to the alphabet of symbols ( [symbol] ₘ), a sequence length (n), and an energy threshold (Ē).

In some examples, in a second stage of the two-stage encoding operation, the communication device may generate (e.g., output) the symbol sequence. For example, the symbol sequence(s) may be output in the second stage of the two-stage encoding operation based on the determined composition (e.g., k*=(k*₁, . . . , k*ₘ)) and the generated information bits. The communication device may transmit the output symbol sequence(s) to another communication device (e.g., a receiving device). The receiving device may obtain the symbol sequence and perform a two-stage decoding operation (e.g., two-stage decoding of direct peeling) to estimate a bit sequence (e.g., based on the obtained symbol sequence).

Particular aspects of the subject matter described herein may be implemented to realize one or more of the following potential advantages. The techniques employed by the described communication devices may provide benefits and enhancements to the operation of the communication devices, including achieving sphere shaping using two-stage encoding (e.g., and two-stage decoding) of direct peeling. For example, operations performed by the described communication devices may provide for a reduced shaping gap and increased reliability of wireless communications. In some implementations, the operations performed by the described communication devices to achieve a reduced shaping gap include iteratively determining a respective composition of each symbol of the symbol alphabet within a symbol sequence. In some other implementations, operations performed by the described communication devices may also support reduced power consumption, increased throughput, and higher data rates, among other possible benefits.

Aspects of the disclosure are initially described in the context of wireless communications systems. Aspects of the disclosure are also described in the context of a partitioning scheme and process flows. Aspects of the disclosure are further illustrated by and described with reference to apparatus diagrams, system diagrams, and flowcharts that relate to techniques for probabilistic shaping using peeling.

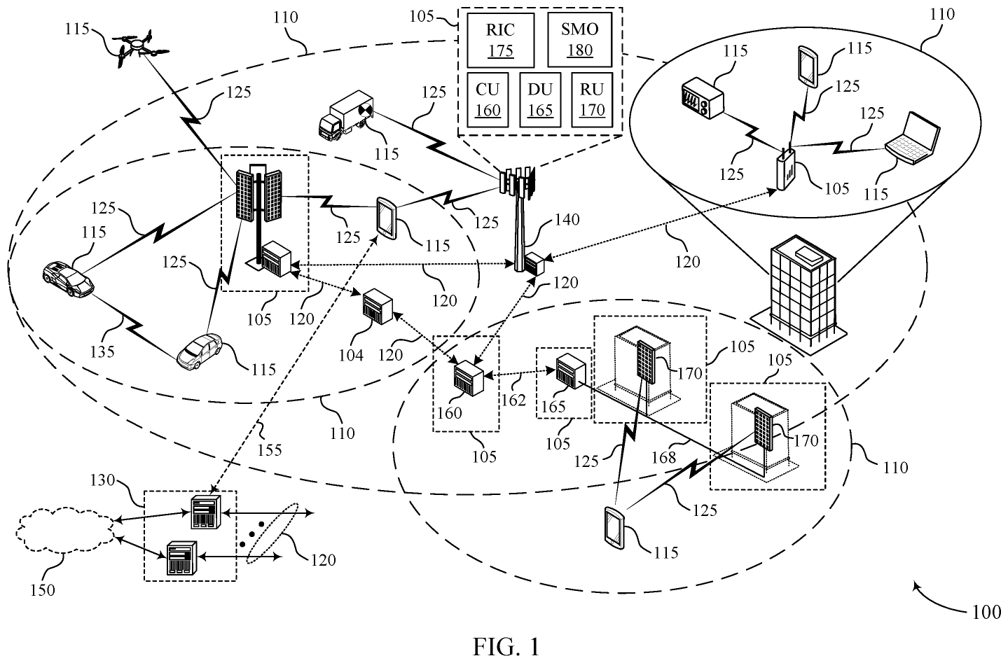

FIG. 1 illustrates an example of a wireless communications system 100 that supports techniques for probabilistic shaping using peeling in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for probabilistic shaping using peeling as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some examples of the wireless communications system 100, a device (e.g., a UE 115, a network entity 105) may obtain multiple information bits and perform a two-stage encoding operation using the multiple information bits. In some examples, as part of the two-stage encoding procedure, the device may determine an interval corresponding to an energy threshold for a set of symbol sequences in which each symbol sequence of the set of symbol sequences may have a same length (e.g., a same quantity of elements). In a first stage of the two-stage encoding operation, the device may determine a composition of a symbol sequence of the set of symbol sequences based on the multiple information bits. In some examples, a first element of the composition may be determined in a first iteration of the first stage of the two-stage encoding operation based on a first transition associated with a first transition probability. The first element of the composition may correspond to a quantity of occurrences of a first symbol of an alphabet of symbols used for generating the symbol sequence. In some examples, a first subinterval of the interval may correspond to the first transition.

Additionally, or alternatively, the device may determine a second element of the composition in a second iteration of the first stage of the two-stage encoding operation based on a second transition associated with a second transition probability. The second element of the composition may correspond to a quantity of occurrences of a second symbol of the alphabet of symbols used for generating the symbol sequence. A second subinterval of the interval may correspond to the second transition. In some examples, in a second stage of the two-stage encoding operation, the device may generate the symbol sequence based on the multiple information bits and the composition. In such examples, an energy of the symbol sequence may be less than or equal to the energy threshold. The device may transmit the symbol sequence to another device using a wireless medium.

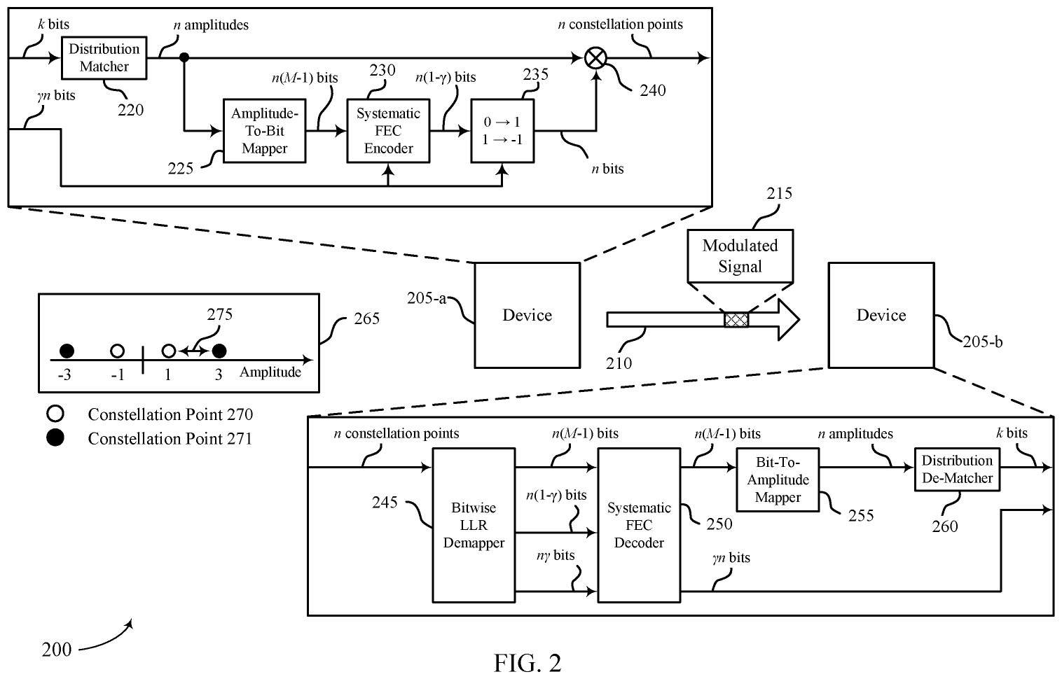

FIG. 2 illustrates an example of a wireless communications system 200 that supports techniques for probabilistic shaping using peeling in accordance with one or more aspects of the present disclosure. In some examples, the wireless communications system 200 may implement aspects of the wireless communications system 100. For example, the wireless communications system 200 may include a device 205-a and a device 205-b, which may each be an example of a UE 115 or a network entity 105 as described with reference to FIG. 1.

In the example of FIG. 2, the device 205-a may be a transmitting device (e.g., a device that may perform one or more encoding operations) and the device 205-b may be a receiving device (e.g., a device that may perform one or more decoding operations). The device 205-a and the device 205-b may communicate via a communication link 210, which may be an example of a communication link 125 as described with reference to FIG. 1. In the example of FIG. 2, the communication link 210 may be a downlink, an uplink, or a sidelink, among other examples.

In some examples of the wireless communications system 200, a communication device (e.g., the device 205-a, the device 205-b) may support one or more amplitude shift keying (ASK) modulation schemes. For example, as illustrated in the example of FIG. 2, the device 205-a may transmit a modulated signal 215 that may be illustrated using an ASK constellation diagram 265. For example, information (e.g., k bits) transmitted via the modulated signal 215 may be represented as symbols (e.g., amplitudes encoded over a time duration of the modulated signal 215) and each symbol may be represented as a point (e.g., a constellation point 270 or a constellation point 271) on the ASK constellation diagram 265. That is, the k bits may be represented as n constellation points and each constellation point (e.g., each constellation point 270 and each constellation point 271) illustrated by the ASK constellation diagram 265 may correspond to a symbol of a modulated signal with a particular amplitude. Although the example of FIG. 2 illustrates a one-dimensional (1D) constellation (e.g., a constellation that may use an amplitude alphabet of [symbol] ₂={1, 3}), the techniques described herein may be extended to a two-dimensional constellation (2D). That is, the wireless communications system 200 may employ ASK constellations that may be extended to QAM constellations, for example by mapping two ASK constellation points to one QAM constellation points (e.g., one for an in-phase component (i) and one for a quadrature component (q)

In some examples, the k bits may be mapped to (e.g., represented by) symbols according to an alphabet. For example, for an alphabet [symbol] ₘ and an alphabet [symbol] ₜ, m may correspond to an integer greater than about 1 (e.g., m>1) and [symbol] ₘ={a₁, a₂, . . . , aₘ} may correspond to a finite symbol alphabet of size m. That is, the symbol alphabet [symbol] ₘ may include m elements (e.g., symbols). In such an example, an ordering may be imposed on the alphabet [symbol] ₘ, such that a value of a; may be less than a value of aᵢ₊₁ (e.g., aᵢ<aᵢ₊₁) for each i (e.g., a₁<a₂< . . . aₘ). Additionally, or alternatively, for a particular value of m and for each integer t between 1 and m, [symbol] ₜ may be a subset of [symbol] ₘ including symbol aᵢ for i≤t. That is, [symbol] ₜ may be expressed according to the following Equation 1:

$${t}_{} = \{ {a}_{i} ∈ {m}_{} \vert i \leq t \} . \qquad ( 1 )$$

For example, [symbol] ₁={a₁}, [symbol] ₂={a₁, a₂}, and [symbol] ₘ₋₁={a₁, a₂, . . . , a₍ₘ₋₁₎}. That is, [symbol] ₁ may be a subset of or equal to [symbol] ₂, which may be a subset of or equal to [symbol] ₘ (e.g., [symbol] ₁ ⊆ [symbol] ₂ ⊆ [symbol] ₘ).

In such an example, a sequence over [symbol] ₘ (e.g., a symbol sequence including symbols of the alphabet [symbol] ₘ, a symbol sequence generated using [symbol] ₘ) and having length n may be referred to as an ordered n-tuple, in which elements of the sequence may correspond to values included in [symbol] ₘ. That is, a sequences over [symbol] ₘ and having length n may refer to a sequence of n elements, in which each element (e.g., symbol) of the sequence may be included in (e.g., belongs to) [symbol] ₘ. In some examples, a value of m may be relatively small, while a value of n may be relatively large. Additionally, or alternatively, a sequence(s) may be denoted by s₁^{t} with the prefix (s₁, s₂, . . . , sₜ) of s, such that the sequence(s) may also be denoted by s₁ⁿ. That is, the prefix of a sequence may refer to a portion of the sequence that may begin from a relatively first symbol of the sequence (e.g., t may be equal to n). Additionally, or alternatively, a composition (k) of a symbol sequence may have a particular size (e.g., cardinality). For example, a composition (k) with a cardinality m may be an ordered m-tuple (e.g., k=(k₁, k₂, . . . , kₘ)), and the elements of k may belong to a set {0,1, . . . , n} and may correspond to a summation of a value of n. In some examples, for a symbol sequence(s) of length (n) over the alphabet [symbol] ₘ, the composition of s may be an ordered m-tuple (e.g., k(s)=(k₁ (s), k₂ (s), . . . , kₘ(s))), in which kᵢ may correspond to a quantity of occurrences of aᵢ ∈ [symbol] ₘ.

In some examples, an amplitude shift keying (ASK) constellation (e.g., a constellation of an 2^{M}-ary ASK modulation scheme) may be associated with a symbol (e.g., amplitude) alphabet of [symbol] ₘ={1,3, . . . 2^{M}−1}, such that m=2^{M-1} and {−1,1}× [symbol] ₘ may correspond to an 2^{M}-ary ASK alphabet. That is, a cardinality (m) of an alphabet used with a modulation scheme to generate a symbol sequence (e.g., a constellation) may depend on a modulation order of the modulation scheme. For example, for an 8 ASK modulation scheme (e.g., an ASK modulation scheme with a modulation order of 8), a value of M may be equal to about 3 (e.g., 2³=8) and, therefore, may be associated with a symbol alphabet having a cardinality of about 4 symbols (e.g., m=4). In some examples, for the 8 ASK modulation scheme, the symbol alphabet ( [symbol] ₘ) with m=4 may be written in accordance with Equation 2:

$${4}_{} = \{ 1 , 3 , 5 , 7 \} . \qquad ( 2 )$$

In such an example, some subsets (e.g., prefixes) of [symbol] ₄ may include [symbol] ₃={1, 3, 5}, [symbol] ₂={1, 3}, and [symbol] ₁={1}.

As an illustrative example, an alphabet [symbol] ₘ for m=2 may include [symbol] ₂={1, 3}. In such an example, a symbol sequence(s) with a length of n=4 generated using the alphabet [symbol] ₂={1, 3} may be written as s=(1, 1, 3, 1) and a prefix of s may be written as s₁²=(1, 1). In such an example, a composition (k) of s=(1, 1, 3, 1) may be written in accordance with the following Equation 3:

$$k ( s ) = ( 3 , 1 ) \qquad ( 3 )$$

and a quantity ( [symbol] ) of sequences having a composition k(s)=(3, 1) may be determined using a multinomial coefficient in accordance with Equation 4:

$$( ( 3 , 1 ) ) {=}^{△} ( \begin{matrix}n ( 3 , 1 ) \\ ( 3 , 1 )\end{matrix} ) = \frac{4 !}{3 ! 1 !} = 4. \qquad ( 4 )$$

That is, sequences generated using (e.g., over) the alphabet [symbol] ₂ and having a composition (3, 1) may include (1, 1, 1, 3), (1, 1, 3, 1), (1, 3 1, 1), and (3, 1, 1, 1).

Additionally, or alternatively, an energy of a symbol aᵢ (e.g., given an alphabet [symbol] ₘ={a₁, a₂, . . . , aₘ} with a cardinality m), may be denoted as E(aᵢ) for each i. In such an example, the symbol energies may be distinct (e.g., and assumed) for any i ∈{1, 2, . . . , m−1}, in which 0≤E (aᵢ)<E (aᵢ₊₁). That is, the energy of a symbol may correspond to a non-negative value (e.g., a non-negative integer). In some examples (e.g., for ASK constellations), an alphabet [symbol] ₘ={1, 3, . . . , 2^{M}−1} may be selected, such that m=2^{M-1} and {−1, 1}× [symbol] ₘ corresponds to a 2^{M}-ary ASK alphabet (e.g., m depends on a modulation order of the ASK modulation scheme). In such examples, aᵢ=2i−1, such that a₁=1, a₂=3, and aₘ=2^{M}−1. In some examples, the symbol energy (E(aᵢ)) may be determined in accordance with the following Equation 5:

$$E ( {a}_{i} ) = {( 2 i - 1 )}^{2} . \qquad ( 5 )$$

Additionally, or alternatively, the symbol energy may be determined in accordance with the following Equation 6:

$$E ( {a}_{i} ) = \frac{i ( i - 1 )}{2} . \qquad ( 6 )$$

In such examples, if 8E(aᵢ)+1=(2i−1)², determining the symbol energy (E(aᵢ)) may include a rescaling of (2i−1)².

In some examples, a symbol sequence (e.g., generated using an alphabet [symbol] ₘ={a₁, a₂, . . . , aₘ} with a cardinality m) may be written as s=(s₁, s₂, . . . , sₙ) in which each element of s may correspond to an element of the alphabet [symbol] ₘ. In such examples, the energy of the sequence(s) may be denoted as E(s) and may be defined as an accumulation (e.g., summation) of symbol energies (E(aᵢ)) of symbols included in the sequence. For example, the sequence energy (E(s)) may be written in accordance with Equation 7:

$$E ( s ) = {\sum }_{l = 1}^{n} E ( {s}_{l} ) . \qquad ( 7 )$$

In some examples, an energy (E(aᵢ)) of a symbol corresponding to a constellation point (e.g., a constellation point 270 or a constellation point 271) on the ASK constellation diagram 265 may be proportional to the square of the distance (e.g., the Euclidean distance, a distance 275) between the constellation point and the origin of the ASK constellation diagram 265. Additionally, or alternatively, the distance between constellation points may correspond to a noise tolerance. For example, a relatively larger distance may correspond to a relatively larger noise tolerance (e.g., of the symbol). As such, an average SNR of the ASK constellation diagram 265 (e.g., and an average energy) may correspond to a distribution of the constellation points (e.g., the constellation points 270 and the constellation points 271) within the ASK constellation diagram 265.

Constellations (e.g., constellation diagrams of modulated signals) in some systems that use higher-order modulation (e.g., 16 QAM, 64 QAM, 256 QAM) may be fixed and each constellation point (e.g., of a constellation diagram) may be used with about equal probability. For example, within the constellation diagram, each constellation point (e.g., associated with a particular phase and amplitude) may have a same (or about the same) probability of being selected (e.g., being transmitted). That is, each symbol in a modulated signal (e.g., a symbol sequence) associated with the constellation may be associated with a same fractional occurrence. In such an example, the constellation points (e.g., symbols) may have relatively high amplitudes, and relatively high power, may have a same probability of being selected (e.g., transmitted) as constellation points that may have relatively low amplitudes (e.g., and relatively low power). That is, a distribution of the constellation points within the constellation diagram may be uniform.

In some examples, the device 205-a and the device 205-b may support higher-order modulation (e.g., 16 QAM, 64 QAM, 256 QAM) for wireless communications. For example, the device 205-a (e.g., a transmitting device) may implement higher-order modulation to improve a reliability (or throughput) with which another communication device (e.g., the device 205-b, a receiving device) may recover original source information. In some examples, as a modulation order of a modulation scheme used to generate a modulated signal increases, an information rate that may be achieved using the modulation scheme (e.g., with uniform signaling) may be reduced relative to a capacity of the channel (e.g., a communication channel used for transmitting the modulated signal). For example, the capacity of a channel (e.g., a channel capacity, an upper bound of a quantity of bits that may be transmitted per symbol, an upper bound of a rate at which information may be transmitted relatively reliably using the communication channel) achievable using a modulation scheme (e.g., 16 QAM, 64 QAM, or 256 QAM) may be associated with an SNR of the modulated signal (e.g., obtained using the modulation scheme). As such, a modulation and coding scheme may have a particular SNR to achieve a particular information rate. In some examples, a difference between an SNR (e.g., of a modulated signal) at which a particular information rate may be achieved and another SNR at which channel capacity may be achieved (e.g., an SNR associated with an information rate of a maximum capacity-achieving scheme or otherwise suitable capacity-achieving scheme) may be referred to as a shaping gap. That is, the shaping gap may refer to a difference between a rate of information (e.g., the information rate) achievable using a modulation and coding scheme and the channel capacity (e.g., an unconstrained channel capacity) of an additive white Gaussian noise (AWGN) channel at a particular SNR. In some examples, the shaping gap may be equal to (e.g., asymptotically equal to) about 1.53 dB for increased (e.g., relatively large) information rates. That is, the shaping gap may approach a value of about 1.53 dB for increased (e.g., relatively large) information rates compared to other information rates achievable for some MCSs.

In some examples, constellation shaping may be applied to reduce the shaping gap. For example, if a distribution (e.g., an input distribution of a symbol alphabet associated with constellation points within an ASK constellation diagram) may be a 1D Gaussian-like distribution (e.g., over a real line), an increased channel capacity of the modulation scheme (e.g., over an AWGN channel) may be achieved. For example, a noise of a modulated signal may be reduced by reducing an average energy of the corresponding constellation. That is, an average SNR of the ASK constellation diagram may be increased (e.g., and an average energy reduced) by varying the relative distance between constellation points or by varying a probability with which particular constellation points may be selected (e.g., by varying the fractional occurrence of the constellation points). For example, the average energy of the ASK constellation diagram may be reduced by increasing the fractional occurrence of constellation points that may be a relatively small distance from the origin (e.g., constellation points that may have a relatively low energy) and reducing the fractional occurrence of constellation points that may be a relatively large distance from the origin (e.g., constellation points that may have a relatively high energy).

For example, some techniques to reduce (e.g., close) the shaping gap (e.g., and reduce the SNR) may include geometric shaping and probabilistic shaping. Geometric shaping may implement equiprobable signaling with Gaussian-like distributed constellation points. That is, for geometric shaping, constellation points may be selected (e.g., transmitted) with about equal probability and a relative distance between different constellation points within the constellation diagram (e.g., a distance 275) may be different (e.g., to achieve a Gaussian distribution). Probabilistic shaping may employ equidistant constellation points and may implement one or more non-uniform (e.g., Gaussian-like) signal distributions. That is, for probabilistic shaping, a relative distance between different constellation points (e.g., within the constellation diagram) may about equal and a probability of selecting a particular constellation point (e.g., to be transmitted) may be non-uniform (e.g., Gaussian-like). For example, constellation points with relatively low amplitudes (e.g., relatively low power, relatively low energy) may have an increased probability of being selected compared to constellation points with relatively high amplitudes (e.g., relatively high power, relatively high energy), such as to achieve a Gaussian-like signal distribution.

In some examples, the probability distribution of constellation points for probabilistic shaping may be modified to achieve a discrete Gaussian-like distribution, such as Maxwell-Boltzmann distribution. For example, a Maxwell-Boltzmann distribution of constellation points (e.g., amplitudes within a constellation diagram, such as the ASK constellation diagram 265) may provide a symmetric probability distribution, pᵥ(z), of a form described according to the following Equation 8:

$${p}_{v} ( z ) = \frac{1}{{Z}_{v}} {e}^{- v {z}^{2}} , z ∈ \{ \pm 1 , \pm 3 , … , \pm ( {2}^{M} - 1 ) \} \qquad ( 8 )$$

where v may correspond to a non-negative real number. For example, a 2^{M}-ary ASK constellation may include a set of symbols (e.g., {±1, ±3, . . . , ±(2^{M}−1)}) with an amplitude alphabet (e.g., [symbol] ={1,3, . . . , 2^{M}−1}). In some examples, a Maxwell-Boltzmann-distributed input may exhibit a shaping gain (e.g., an increase in the information rate for a same power or an increase in energy efficiency for a same information rate achieved by probabilistic shaping relative to signaling using an AWGN channel) relative to a uniformly distributed input (e.g., within an ASK constellation, relative to a constellation for an ASK modulation scheme). In some examples, the shaping gain may be about 1.243 dB relative to a uniform input (e.g., a uniform distribution of constellation points 270 and constellation points 271) for a 32 ASK modulation scheme.

Some examples (e.g., approaches, architectures) of probabilistic shaping may include trellis shaping and shell mapping. Additionally, or alternatively, probabilistic amplitude shaping (PAS) may be used (e.g., at the device 205-a, or the device 205-b, or both) as a technique to perform probabilistic shaping. For example, PAS may combine an outer layer of shaping (e.g., constellation shaping) with an inner layer of binary forward-error-correction (FEC) to provide a relatively low-complexity (or otherwise suitable complexity) and flexible integration with existing bit-interleaved coded modulation (BICM) schemes. In some examples, PAS may provide relatively large (or otherwise suitable) shaping gain and inherent rate (e.g., information rate) adaptation functionality.

Some PAS systems may achieve sphere shaping, in which bit sequences (e.g., input of the PAS) may be mapped (e.g., implicitly) to symbol sequences based on an energy of the symbol sequences (e.g., according to an ordering of the symbol sequences that may be based on a respective energy of each sequence). For example, techniques that achieve sphere shaping may lead to an implicit mapping of bit sequences to symbol sequences according to the following Table 1:

TABLE 1

| Bit Sequence | Symbol Sequence | Energy |
|---|---|---|
| (0, 0, 0, 0) | (1, 1, 1, 1, 1) | 5 |
| . | . | . |
| . | . | . |
| . | . | . |
| (0, 0, 1, 1) | (1, 1, 3, 1, 1) | 13 |
| . | . | . |
| . | . | . |
| . | . | . |
| (1, 0, 1, 0) | (1, 3, 1, 3, 1) | 21 |

That is, in accordance with Table 1, a bit sequence may be mapped to a symbol sequence (e.g., using an alphabet that includes the values 1 and 3) based on the respective energy of the symbol sequence. For example, in some contexts, sphere shaping may consider a quantity (e.g., 2^{k}) of symbol sequences of length (n) with a relatively low (e.g., a minimal or otherwise suitable) energy. In some examples, the mapping between a length-k bit sequences to length-n symbol (e.g., amplitude) sequences may be one-to-one (e.g., a single bit sequence may be mapped to a single symbol sequence). As such, techniques that achieve sphere shaping (e.g., using symbol sequences with low energy relative to other possible symbol sequences) may lead to a distribution (e.g., a marginal distribution) that may approach (e.g., be relatively close to) a Maxwell-Boltzmann distribution (e.g., a discrete Gaussian-like distribution). That is, a Gaussian-like distribution of an amplitude alphabet (e.g., [symbol] ₂={1, 3}) associated with the constellation may be obtained from techniques that achieve sphere shaping. Additionally, or alternatively, some techniques for achieving sphere shaping may lead to increased shaping gain (e.g., a near maximum or otherwise suitable shaping gain) and reduced energy use (e.g., minimum energy use or otherwise suitable energy use) for an information rate.

In some examples, sphere shaping may occur at a distribution matcher 220. For example, as illustrated in the example of FIG. 2, the device 205-a (e.g., a transmitting device) may use the distribution matcher 220 (e.g., a non-linear precoder) to transforms (e.g., convert) uniformly (e.g., regularly) distributed bit sequences into symbol sequences with a non-uniform (e.g., irregular) distribution. That is, the device 205-a may use the distribution matcher 220 to generate a symbol sequence of n amplitudes from a bit sequence of k bits. For example, the distribution matcher 220 (e.g., a fixed-to-fixed distribution matcher) may map a length-k bit sequence to a length-n amplitude sequence and induce a non-uniform (e.g., marginal) distribution of the amplitude symbols {1, 3, . . . , 2^{M}−1}. In some examples, the k bits may be independent and distributed (e.g., identically distributed) with a uniform distribution. Additionally, or alternatively, the non-uniform distribution over the amplitude symbols (e.g., using the amplitude symbols) may be closer to the capacity-achieving distribution relative to the uniform distribution. That is, the non-uniform distribution may be a Gaussian-like distribution (e.g., may approximate a Gaussian distribution) or may be a Maxwell-Boltzmann distribution (e.g., in the AWGN context). In some examples, the distribution matcher 220 may have a distribution matching rate determined in accordance with the following Equation 9:

$${R}_{dm} = \frac{k}{n} \qquad ( 9 )$$

where k may correspond to a quantity of bits (e.g., information bits) input into the distribution matcher 220 and n may correspond to a quantity of symbol amplitudes (e.g., symbols) output from the distribution matcher 220. The device 205-a may use an amplitude-to-bit mapper 225 to generate n(M−1) bits (e.g., n(M−1) amplitude bits) from the n amplitudes. The n(M−1) bits and some other bits (e.g., γn bits, where γ may be an integer, such as a nonnegative integer) may be input into a systematic FEC encoder (e.g., a systematic FEC encoder 230) to generate n(1−γ) bits (e.g., n(1−γ) parity bits). In some examples, the systematic FEC encoder 230 may have a systematic FEC code rate determined in accordance with Equation 10:

$${R}_{c} = \frac{M - 1 + γ}{M} . \qquad ( 10 )$$

In some examples, at 235, the device 205-a may use the n(1−γ) bits and the γn bits to generate n bits (e.g., n sign bits). In some examples, as part of generating the n bits, the device 205-a may map bits with a value of 0 to bits with a value of 1. Additionally, or alternatively, the device 205-a may map bits with a value 1 to bits with a value of −1. The device 205-a may use a modulator 240 (e.g., may multiply, such as point-wise, the n bits (e.g., n sign bits) with the n amplitudes) to generate n constellation points (e.g., a modulated signal 215 including n constellation points). In some examples, the device 205-a may transmit the modulated signal 215 (e.g., the n constellation points) to the device 205-b. For example, the device 205-a may transmit the n constellation points with a transmission rate determined in accordance with Equation 11:

$${R}_{t} = {R}_{dm} + γ . \qquad ( 11 )$$

In some examples, the device 205-b (e.g., a receiving device) may receive the modulated signal 215 (e.g., the n constellation points) and use a bitwise log likelihood ratio (LLR) demapper (e.g., a bitwise LLR demapper 245) to extract (e.g., generate) the n(M−1) bits (e.g., the n(M−1) amplitude bits), the n(1−γ) bits (e.g., the n(1−γ) parity bits), and my bits. In such an example, the device 205-b may input the n(M−1) bits, the n(1−γ) bits, and the nγ bits into a systematic FEC decoder 250. The n(M−1) bits output from the systematic FEC decoder 250 may be input into a bit-to-amplitude mapper 255 to generate (e.g., extract) the n amplitudes. The device 205-b may input the n amplitudes into a distribution dematcher 260 to estimate (e.g., extract) the k bits (e.g., the k information bits).

Some techniques (e.g., algorithms) for achieving sphere shaping may lead to increased computation (e.g., relatively high computation cost) or storage complexity at the device 205-a (e.g., and the device 205-b). In some examples, techniques for probabilistic shaping using peeling, as described herein, may provide one or more encoding and decoding techniques. For example, such techniques may be used to induce an implicit mapping from bit sequences to relatively low energy symbol sequences in a relatively efficient (e.g., practically efficient) manner. That is, encoding of direct peeling implicitly defines an injective mapping from a set of bit sequences (e.g., that may each have a same length (k)) to a set of symbol sequences ( [symbol] (m, n, E)) that may have a same length (n), may be generated using a same alphabet [symbol] ₘ, and may have an energy that may be less than or equal to (e.g., may be at most equal to, fails to exceed) Ē.

In some examples, techniques for probabilistic shaping using peeling (e.g., encoding of direct peeling), as described herein, may be used to perform distribution matching in a PAS scheme. For example, such techniques may provide a method to achieve sphere shaping, thereby providing (e.g., offering) increased (e.g., relatively large, near maximum, or otherwise suitable) shaping gain. Additionally, or alternatively, decoding of direct peeling may be used to perform distribution dematching in a PAS scheme. That is, techniques for probabilistic shaping using peeling, as described herein, may provide one or more relatively efficient ways to encode (e.g., map) length-k bit sequences into length-n symbol sequences (e.g., in a set of symbol sequences that may be represented as [symbol] (m, n, E)) and to provide decodability (e.g., unique decodability).

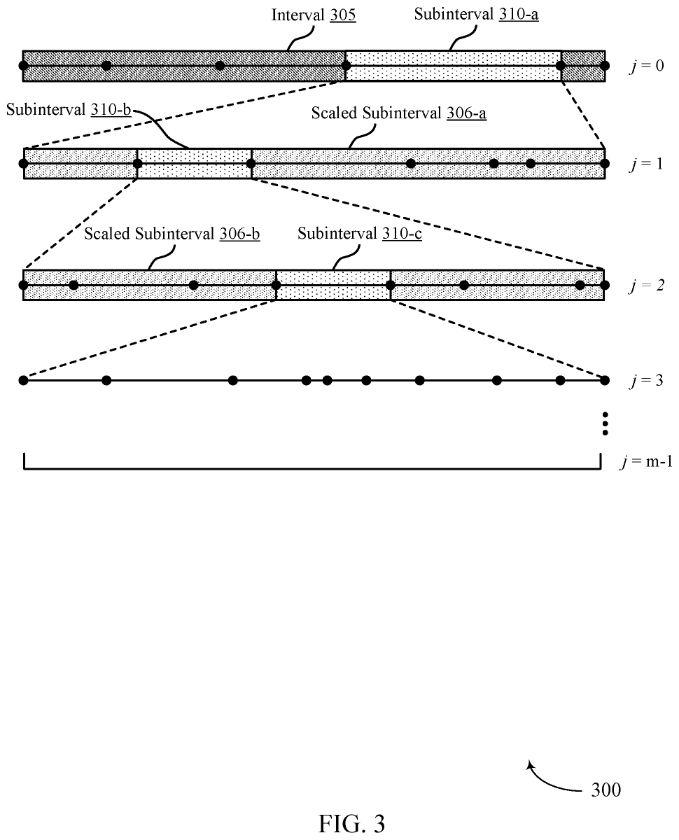

FIG. 3 illustrates an example of a partitioning scheme 300 that supports techniques for probabilistic shaping using peeling in accordance with one or more aspects of the present disclosure. In some examples, the partitioning scheme 300 may implement aspects of the wireless communications system 100 and the wireless communications system 200. For example, the partitioning scheme 300 may be implemented at a device, which may be an example of a device as described with reference to FIGS. 1 and 2.

In some examples, a communication device may be capable of realizing a mapping from bit sequences to relatively low energy symbol sequences using encoding of direct peeling. For example, a communication device may perform a two-stage encoding operation (e.g., encoding of direct peeling), in which the communication device may determine a composition k*=(k*₁, . . . , kₘ) in a first stage and, in a second stage, may use the composition to determine symbols of a sequence (e.g., an output sequence(s)). As illustrated in the example of FIG. 3, the first stage of the two-stage encoding operation may be illustrated using a unit interval refinement process including multiple (e.g., m−1) refinements.

In some examples, the interval refinement process may provide (e.g., illustrate) partitioning of an interval that may correspond to a set of sequences that may be represented as [symbol] (m, n, Ē). For example, the interval may be represented as [0, 1) and may correspond to a set {m, n, Ē}. As described herein, the set {m, n, Ē} may refer to [symbol] (m, n, Ē). In some examples, m may be a positive integer and n and Ē may be nonnegative integers. For example, a symbol alphabet represented as [symbol] ₘ={a₁, a₂, . . . , aₘ} may have a cardinality m and each symbol of the alphabet (e.g., aᵢ) may have an energy that may be represented as E(aᵢ). That is, [symbol] (m, n, Ē) may represent a set of symbol sequences that may each have a length n, be generated using an alphabet [symbol] ₘ, and have an energy that may be less than or equal to (e.g., may be at most equal to, fails to exceed) Ē. Accordingly, the interval may correspond to an alphabet of symbols ( [symbol] ₘ), a sequence length (n), and an energy threshold (Ē). That is, an energy of a sequence(s₁ⁿ) of the set [symbol] (m, n, Ē) may be represented in accordance with the following Equation 12:

$$E ( {s}_{1}^{n} ) \leq \overline{E} , {s}_{1}^{n} ∈ ( m , n , \overline{E} ) . \qquad ( 12 )$$

In some examples, a cardinality (e.g., a quantity of sequences, a cumulative sequence quantity) of the set [symbol] (m, n, Ē) may be represented by the following Equation 13:

$$\vert ( m , n , \overline{E} ) \vert = {N}_{c}^{[ m ]} ( n , \overline{E} ) \qquad ( 13 )$$

in which N_{c}^{[m]}(n, Ē) may denote a quantity of symbol sequences generated using the alphabet [symbol] ₘ and each sequence may have a length n and an energy that may be less than or equal to (e.g., at most) an energy threshold (Ē). In such an example, n and Ē may correspond to nonnegative integers, the alphabet [symbol] ₘ may correspond to an alphabet with a cardinality m (e.g., [symbol] ₘ={a₁, a₂, . . . , aₘ}), and each symbol of the alphabet (aᵢ) may have an energy that may be represented as E(aᵢ). For example, [symbol] (m, n, E) may be represented in accordance with the following Equation 14:

$$\{ s = ( {s}_{1} , {s}_{2} , … , {s}_{n} ) \vert {s}_{i} ∈ {m}_{} , ∀ i , E ( s ) \leq \overline{E} \} . \qquad ( 14 )$$

That is, for all symbol sequences(s) generated using the alphabet [symbol] ₘ, the energy of the sequence (E(s)) may be less than or equal to Ē. In such an example, the set of all sequences generated using the alphabet [symbol] ₘ, having length n, and having an energy (E(s)) that may be less than or equal to (e.g., at most) Ē may have a cardinality (N_{c}^{[m]}(n, Ē)) that may be represented in accordance with Equation 15:

$${N}_{c}^{[ m ]} ( n , \overline{E} ) = \vert \{ s = ( {s}_{1} , {s}_{2} , … , {s}_{n} ) \vert {s}_{i} ∈ {m}_{} , ∀ i , E ( s ) \leq \overline{E} \} \vert . \qquad ( 15 )$$

In some examples, if a cardinality (e.g., an underlying size) of the alphabet [symbol] ₘ may be determined (e.g., clear from context), N_{c}^{[m]}(n, Ē) may be represented (e.g., as a proxy) as N_{c} (n, Ē). For example, if a cardinality (e.g., size) of an alphabet corresponds to m=4 and the alphabet (e.g., [symbol] ₄) may be such that E(a₁)=0, E(a₂)=1, E(a₃)=3, and E(a₄)=6, a logarithm of N_{c} (n, Ē) (e.g., a log N_{c} (n, Ē)) may range from 0 to 1300 (e.g., with n ranging from 0 to about 900 and Ē may be equal to about 6000 Joule (J)).

In some examples, the energy threshold (Ē) may depend on the alphabet [symbol] ₘ and the length of the sequence (n). For example, a relatively low symbol energy (e.g., a minimum symbol energy or an otherwise suitable symbol energy) and a relatively high symbol energy (e.g., a maximum symbol energy or an otherwise suitable symbol energy) may be represented as E(a₁) and E(aₘ), respectively. Additionally, or alternatively, a relatively low sequence energy (e.g., a minimum sequence energy or an otherwise suitable sequence energy) and a relatively high sequence energy (e.g., a maximum sequence energy or an otherwise suitable sequence energy) of a length-n symbol sequence over the alphabet [symbol] ₘ may be represented as nE(a₁) and nE(aₘ), respectively, which may provide a relatively smallest bound of Ē (e.g., a relatively smallest Ē) and a relatively largest bound of Ē (e.g., a relatively largest Ē).

In some examples, the parameter Ē may be represented in accordance with a form (e.g., a particular form) an, in which a may represent a value between E (a₁) and E(aₘ) and n may represent the symbol sequence length. In such examples, a parameter a may represent an average symbol energy that may be represented in accordance with Equation 16:

$$α = \frac{1}{m} {\sum }_{i = 1}^{m} E ( {a}_{i} ) . \qquad ( 16 )$$

Additionally, or alternatively, the parameter a may represent a function of e^{-v}, in which a parameter v may represent a parameter of some Maxwell-Boltzmann distribution. In some examples, techniques for probabilistic shaping using peeling, as described herein, may use one or more particular values (e.g., choices) of Ē.

In some examples, the communication device may generate a length-k bit sequence (e.g., a k-bit sequence) as input for the two-stage encoding operation. For example, k may correspond to an integer (e.g., a relatively largest integer or an otherwise suitable integer) that may satisfy the following Equation 17:

$${2}^{- k} \geq \frac{1}{{N}_{c}^{[ m ]} ( n , \overline{E} )} \qquad ( 17 )$$

Additionally, or alternatively, the k-bit sequence (u₁, u₂, . . . , uₖ), including the information bits (e.g., the k-bit sequence may include the information bits in a particular order), may be interpreted as a dyadic number (x) with a binary expansion 0. u₁, u₂, . . . , uₖ. That is, the dyadic number x (e.g., a fraction in which the denominator corresponds to a power of two) may be an element (e.g., a candidate element) of an interval in which a set of all number (x) within the interval may be greater than or equal to 0 and less than 1 (e.g., x ∈[0,1)) and may be expressed in accordance with Equation 18:

$$x = {\sum }_{i = 1}^{k} {u}_{i} {2}^{- i} . \qquad ( 18 )$$

In some examples, the dyadic number x, the alphabet [symbol] ₘ, the symbol sequence length n, and the threshold energy (e.g., the maximum energy or otherwise suitable energy) Ē, may be available (e.g., to the communication device) for the encoding of direct peeling. As such, the encoding of direct peeling may lead to a mapping (e.g., an implicit mapping) of the k-bit sequence (u₁, u₂, . . . , uₖ) to a length-n symbol sequence (s=(s₁, s₂, . . . , sₙ)) in a set of symbol sequences ( [symbol] (m, n, Ē)). In such examples, k (e.g., the selection of k) may enable the mapping (e.g., of the bit sequence to the symbol sequence) to be injective. For example, a value of k may be selected, such that the mapping (e.g., the implicit mapping) of the k-bit sequence (e.g., the input) to the length-n symbol sequence (e.g., the output) may be represented as an injective function (e.g., an injection, a one-to-one function) that maps distinct elements to distinct elements (e.g., f(x₁)=f (x₂) may imply that x₁=x₂). That is, techniques for encoding of direct peeling, as described herein, may lead to a one-to-one mapping of a k-bit sequence to a length-n symbol sequence.

In some examples of encoding of direct peeling, as described herein, a first stage (e.g., a first stage of the two-stage encoding operation) may be used to determine a composition k*=(k*₁, . . . , k*ₘ) of an output sequence (e.g., a symbol sequence(s) to be output in a second stage of the two-stage encoding operation) in a quantity (e.g., m−1) of iterations. For example, in each iteration (e.g., peel), the first stage may be used to determine k* along a coordinate. That is, a single element of k* may be determined in each iteration. In some examples, determining an element of k* (e.g., during each iteration) may include determining (e.g., accessing, computing, approximating, or looking-up in a table) multiple N_{c} cumulative sequence quantities and binomial coefficients. Additionally, or alternatively, determining an element of k* may include (e.g., involve) computing ratios based on the determined N_{c} cumulative sequence quantities and binomial coefficients, such that each such ratio may be proportional to a product of an N_{c} cumulative sequence quantity and a binomial coefficient. In some examples, the determination of each element of k*may be based on the computed ratios and the input (e.g., scaled input) x. That is, determining an element of k* may include a scaling operation related to x. Additionally, or alternatively, determining an element of k* may include an updated of a residual length and a residual energy (e.g., a residual of the maximum energy or a residual of an otherwise suitable energy) of the output symbol sequence. That is, as part of determining an element of k* (e.g., during an iteration) a residual length and a residual energy associated with the output symbol sequence may be updated. For example, during an iteration j, the residual length (nⱼ₊₁) and the residual energy (Eⱼ₊₁) may be updated (e.g., determined) by decrementing a previous (e.g., a current) residual length (nⱼ) and a previous (e.g., a current) residual energy (Eⱼ) of the output symbol sequence. Additionally or alternatively, in some examples, a range of j may correspond to 0≤j≤m−1.

In some examples, a decrement of residual length (e.g., a quantity in which the residual length may be reduced) in an iteration may be equal to the element of k* determined during the iteration. For example, during the iteration j, the element kₘ₋ⱼ may be determined and, as such, a decrement of the residual length during the first iteration may be equal to kₘ₋ⱼ. Additionally, or alternatively, a decrement of the residual energy (e.g., a quantity in which the residual energy may be reduced) in an iteration may be equal to a product of the determined element of k* and a corresponding energy of the symbol (e.g., the corresponding symbol energy). For example, during the iteration j, the element kₘ₋ⱼ may be determined and a decrement of the residual energy during the iteration j may be equal to kₘ₋ⱼ×E(aₘ₋ⱼ). In some examples, an ordering of the determinations of the elements of k* may be achieved (e.g., by determining each element of k* iteratively). Additionally, or alternatively, the ordering of the determinations of the elements of k* may be unconfined. That is, the techniques described herein may enable any possible ordering of the determinations of the elements (k*ₘ, k*ₘ₋₁, . . . , k*₃, k*₂, k*₁).

In some examples, during a first stage of the two-stage encoding operation, the communication device may perform an initialization. That is, the first stage of encoding may initialize j=0, n₀=n, E₀=Ē, and x₀=x. In some examples, during the first stage of the two-stage encoding operation, the communication device may perform iterations until (and including) j=m−2 (or until j may be equal to some other suitable value). During the iteration j, the communication device may compute one or more ratios (e.g., transition probabilities represented as p (·|m−j, nⱼ, Eⱼ)) in accordance with the following Equation 19:

$$p ( {k}_{m - j} \vert m - j , {n}_{j} , {E}_{j} ) \frac{( \begin{matrix}j \\ {k}_{m - j}\end{matrix} ) {N}_{c}^{[ m - j - 1 ]} ( {n}_{j} - {k}_{m - j} , {E}_{j} - {k}_{m - j} E ( {a}_{m - j} ) )}{{N}_{c}^{[ m - j ]} ( {n}_{j} , {E}_{j} )} \qquad ( 19 )$$

in which kₘ₋ⱼ may correspond to an integer (e.g., a non-negative integer) within a range represented in accordance with the following Equation 20:

$$0 \leq {k}_{m - j} \leq ⌊ \frac{{E}_{j}}{E ( {a}_{m - j} )} ⌋ . \qquad ( 20 )$$

That is, each integer (e.g., of the range of integers represented in accordance with Equation 20) may correspond to a ratio (e.g., transition probability) determined in accordance with Equation 19. An equation that includes a delta-equal-to operator ( [symbol] ), such as Equation 19, may be interpreted as parameters on a left-hand side of the delta-equal-to operation being defined using parameters on a right-hand side of the delta-equal-to operator. In some examples, k*ₘ₋ⱼ may be determined, such that x; may be an element of (e.g., belongs to) an interval with left-closed and right-open boundaries of a form as described in accordance with the following Equation 21:

$${x}_{j} ∈ [ {\sum }_{κ = 0}^{{k}_{m - j}^{*} - 1} p ( κ \vert m - j , {n}_{j} , {E}_{j} ) , {\sum }_{κ = 0}^{{k}_{m - j}^{*}} p ( κ \vert m - j , {n}_{j} , {E}_{j} ) ) . \qquad ( 21 )$$

That is, x; may have a value greater than or equal to Σₖ₌₀^{k*}^{_{m−j}}⁻¹ p(K|m−j, nⱼ, Eⱼ) and less than 93 ₖ₌₀^{k*}^{_{m−j}}p (K|m−j, nⱼ, Eⱼ). In some examples, the communication device may update the value of x by scaling xⱼ to xⱼ₊₁ in accordance with the following Equation 22:

$${x}_{j + 1} = \frac{{x}_{j} - {\sum }_{κ = 0}^{{k}_{m - {j}^{- 1}}^{*}} p ( κ \vert m - j , {n}_{j} , {E}_{j} ,}{p ( {k}_{m - j}^{*} \vert m - j , {n}_{j} , {E}_{j} )} \qquad ( 22 )$$

Additionally, or alternatively, the communication device may update the residual length (nⱼ₊₁) in accordance with the following Equation 23:

$${n}_{j + 1} = {n}_{j} - {k}_{m - j}^{*} \qquad ( 23 )$$

and the residual energy (Eⱼ₊₁) in accordance with the following Equation 24:

$${E}_{j + 1} = {E}_{j} - {k}_{m - j}^{*} E ( {a}_{m - j} ) \qquad ( 24 )$$

and may increase j by 1, which may complete (e.g., end) iteration j.

In some examples, iterations of the first stage (e.g., as described in accordance Equations 19-24) may enable the sequential determination of the elements of the composition k* (e.g., the elements k*ₘ, k*ₘ₋₁, . . . , k*₂), which may specify a quantity of occurrences of the symbols of the alphabet [symbol] ₘ (e.g., the symbols aₘ, aₘ₋₁, . . . , a₂), that may be included in (e.g., appear in) the output sequence(s), respectively. That is, during each iteration of the first stage, an element (e.g., k*ᵢ) of k* may be determined and the element (e.g., k*ᵢ) may correspond to (e.g., specify) a quantity of occurrences of the respective symbol (e.g., at) of the alphabet [symbol] ₘ within the output sequence(s). For example, a composition k*=(k*₁, . . . , k*ₘ) may correspond to a composition of a symbol sequence, in which a quantity of occurrences of the symbol at of the symbol alphabet [symbol] ₘ in the symbol sequence may be equal to k*ᵢ, which may be true for (e.g., hold for) for all i ∈{1, 2, . . . m}. In some examples, a first element (k*₁) of the composition k* may be determined (e.g., subsequent to the determination of the element k*₂) in accordance with the following Equation 25:

$${k}_{1}^{*} = n - {\sum }_{i = 2}^{m} {k}_{i}^{*} \qquad ( 25 )$$

where n may represent the output sequence length (e.g., output in the second stage).

In some examples, during the iteration j=0 (e.g., the relatively first iteration), the communication device may identify a first range (e.g., a first set) of non-negative integers in accordance with Equation 20. That is, an integer (e.g., non-negative integer) may occur within a first range between 0 and a ratio represented as [E₀/E(aₘ)], in which E, may be equal to the energy threshold Ē upon initialization. In such examples, kₘ may be used to denote a generic integer (or variable) in the first range. The communication device may determine multiple binomial coefficients represented as

$$( \begin{matrix}n \\ {k}_{m}\end{matrix} )$$

and multiple cumulative sequence quantities represented as N_{c}^{[m-1]}(n−kₘ, E₀−kₘ E(aₘ). Each binomial coefficient and each cumulative sequence quantity may correspond to a respective integer in the first range. The communication device may further determine multiple transition probabilities in accordance with Equation 19. That is, the communication device may determine multiple transition probabilities (p(kₘ|m, n, Ē)) that may be represented as

$$p ( {k}_{m} \vert m , n , \overline{E} ) = \frac{( \begin{matrix}n \\ {k}_{m}\end{matrix} ) {N}_{c}^{[ m - 1 ]} ( n - {k}_{m} , \overline{E} - {k}_{m} E ( {a}_{m} ) )}{{N}_{c}^{[ m ]} ( n , \overline{E} )} .$$

In some examples, each transition probability (e.g., determined in accordance with Equation 19) may correspond to a respective integer (e.g., non-negative integer) in the first range. For example, the transition probability (p(kₘ|m, n, Ē)) may correspond to an integer (kₘ) in the first range. The communication device may partition an interval 305 into multiple subintervals (e.g., including a subinterval 310-a) based on the determined transition probabilities (e.g., determined in accordance with Equation 19). In some examples, each subinterval of the interval 305 may correspond to a respective transition probability, and a length of each subinterval of the interval 305 may be proportional to a respective transition probability. For example, the subinterval 310-a of the interval 305 may correspond to the transition probability (p(kₘ|m, n, Ē)) and may be represented as [Σₖ₌₀^{k}^{ₘ}⁻¹p(K|m,n,Ē), Σₖ₌₀^{k}^{ₘ}p (k|m, n,Ē)). Additionally or alternatively, a length of the subinterval 310-a may be proportional to the corresponding transition probability (p (kₘ|m, n, Ē)).

In some examples, the communication device may identify the subinterval 310-a using a first number x (e.g., a dyadic number x) and the multiple subintervals within the interval 305. In some examples, the communication device may identify the subinterval 310-a in accordance with Equation 21. That is, the first number x may correspond to a number within the subinterval 310-a. In other words, the first number x may correspond to a first transition probability that the subinterval 310-a corresponds to. The communication device may select a first transition by identifying an integer that the first transition probability corresponds to. The integer may be set to a first element kₘ of the composition k*. The communication device may apply a scaling operation to the first number x in accordance with Equation 22, thereby generating a second number x₁. Additionally, or alternatively, the communication device may apply a scaling operation on the subinterval 310-a, thereby generating a scaled subinterval 306-a. The communication device may update the residual length and the residual energy in accordance with Equation 23 and Equation 24, respectively. That is, the residual length may be represented as n₁=n−k*ₘ and the residual energy may be represented as E₁=Ē−kₘE(aₘ).

Additionally, or alternatively, in a subsequent iteration (e.g., an iteration j=1) in which m>2, the communication device may identify a second range (e.g., a second set) of nonnegative integers in accordance with Equation 20. That is, the communication device may identify the second range of nonnegative integers that may be between 0 and a ratio represented as [E₁/E (aₘ−1)]. In such an example, kₘ₋₁ may be used to denote a generic integer (or variable) in the second range. The communication device may determine multiple binomial coefficients that may be represented as

$$( \begin{matrix}{n}_{1} \\ {k}_{m - 1}\end{matrix} )$$

and multiple cumulative sequence quantities that may be represented as N_{c}^{[m-2]}(n₁−kₘ₋₁, E₁−kₘ₋₁ E(aₘ₋₁)). Each binomial coefficient and cumulative sequence quantity may corresponds to a respective integer in the second range. The communication device may determine multiple transition probabilities in accordance with Equation 19. For example, the communication device may determine multiple transition probabilities (p(kₘ₋₁|m−1, n₁, E₁)) which may be represented as

$$p ( {k}_{m - 1} \vert m - 1 , {n}_{1} , {E}_{1} ) = \frac{( \begin{matrix}{n}_{1} \\ {k}_{m - 1}\end{matrix} ) {N}_{c}^{[ m - 2 ]} ( {n}_{1} - {k}_{m - 1} , {E}_{1} - {k}_{m - 1} E ( {a}_{m - 1} ) )}{{N}_{c}^{[ m - 1 ]} ( {n}_{1} , {E}_{1} )} .$$

In some examples, each transition probability may correspond to a respective integer in the second range; for example, the transition probability (p (kₘ₋₁|m−1, n₁, E₁)) may correspond to an integer (kₘ₋₁) within the second range. The communication device may partition the scaled subinterval 306-a into multiple subintervals (e.g., including a subinterval 310-b) based on the multiple transition probabilities. In some examples, each subinterval within the scaled subinterval 306-a may correspond to a respective transition probability and a length of each subinterval within the scaled subinterval 306-a may be proportional to a respective transition probability. For example, the subinterval 310-b may correspond to a transition probability p(kₘ₋₁|m−1, n₁, E₁) and may be represented as [Eₖ₌₀^{k}^{_{m−1}}⁻¹p (K|m−1, n₁, E₁), Eₖ₌₀^{k}^{ₘ}⁻¹p(K|m−1, n₁, E₁)). Additionally or alternatively, a length of the subinterval 310-b may be proportional to the corresponding transition probability (p(kₘ₋₁|m−1,n₁, E₁)).

In some examples, the communication device may identify the subinterval 310-b using the second number x₁ (e.g., determined during the first iteration, the iteration j=0) and the multiple subintervals (e.g., of the scaled subinterval 306-a). In some examples, the communication device may identify the subinterval 310-b in accordance with Equation 21. That is, the second number x₁ may occur within the subinterval 310-b. In other words, the second number x₁ may correspond to a second transition probability that the subinterval 310-b corresponds to. The communication device may select a second transition by identifying the integer that the second transition probability corresponds to. That integer may be set to be a second element kₘ₋₁ of the composition k*. The communication device may apply a scaling operation to the second number x₁ in accordance with Equation 22, thereby generating a third number x₂. Additionally, or alternatively, the communication device may apply a scaling operation on the subinterval 310-b to generate a scaled subinterval 306-b. The communication device may update the residual length and the residual energy in accordance with Equation 23 and 24, respectively. That is, the residual energy may be represented as n₂=n₁−k*ₘ₋₁ and the residual energy may be represented as E₂=E₁−k*ₘ₋₁E(aₘ₋₁).

Additionally, or alternatively, in a subsequent iteration (e.g., an iteration j=2) in which m>3, the communication device may identify a third range (e.g., a third set) of nonnegative integers in accordance with Equation 20. That is, the communication device may identify the third range of nonnegative integers that may be between 0 and a ratio represented as [E₂/E(aₘ₋₂)]. In such an example, kₘ₋₂ may be used to denote a generic integer in the third range. The communication device may determine multiple binomial coefficients that may be represented as

$$( \begin{matrix}{n}_{2} \\ {k}_{m - 2}\end{matrix} )$$

and multiple cumulative sequence quantities that may be represented as N_{c}^{[m-3]}(n₂−kₘ₋₂, E₂−kₘ₋₂ E (aₘ₋₂).Each binomial coefficient and cumulative sequence quantity may corresponds to a respective integer in the third range. The communication device may determine multiple transition probabilities in accordance with Equation 19. For example, the communication device may determine multiple transition probabilities (p(kₘ₋₂|m−2,n₂, E₂)) which may be represented as

$$p ( {k}_{m - 2} \vert m - 2 , {n}_{2} , {E}_{2} ) = \frac{( \begin{matrix}{n}_{2} \\ {k}_{m - 2}\end{matrix} ) {N}_{c}^{[ m - 3 ]} ( {n}_{2} - {k}_{m - 2} , {E}_{2} - {k}_{m - 2} E ( {a}_{m - 2} ) )}{{N}_{c}^{[ m - 2 ]} ( {n}_{2} , {E}_{2} )} .$$

In some examples, each transition probability may correspond to a respective integer in the third range; for example, the transition probability (p(kₘ₋₂|m−2, n₂, E₂)) may correspond to an integer (kₘ₋₂) within the third range. The communication device may partition the scaled subinterval 306-b into multiple subintervals (e.g., including a subinterval 310-c) based on the multiple transition probabilities. In some examples, each subinterval within the scaled subinterval 306-b may correspond to a respective transition probability and a length of each subinterval within the scaled subinterval 306-b may be proportional to a respective transition probability. For example, the subinterval 310-c may correspond to a transition probability p(kₘ₋₂|m−2, n₂, E₂) and may be represented as [Eₖ₌₀^{K}^{_{m−2}}⁻¹ p(K|m−2, n₂, E₂), Eₖ₌₀^{k}^{ₘ₌₂}p (K|m−2, n₂, E₂)). Additionally or alternatively, a length of the subinterval 310-c may be proportional to the corresponding transition probability (p(kₘ₋₂|m−2,n₂, E₂)).

In some examples, the communication device may identify the subinterval 310-c using the third number x₂ (e.g., determined during the second iteration, the iteration j=1) and the multiple subintervals (e.g., of the scaled subinterval 306-b). In some examples, the communication device may identify the subinterval 310-c in accordance with Equation 21. That is, the third number x₂ may occur within the subinterval 310-c. In other words, the third number x₂ may correspond to a third transition probability that the subinterval 310-c corresponds to. The communication device may select a third transition by identifying the integer that the third transition probability corresponds to. That is, the integer may be set to be a third element kₘ₋₂ of the composition k*. The communication device may apply a scaling operation to the third number x₂ in accordance with the Equation 22. Additionally, or alternatively, the communication device may apply a scaling operation on the subinterval 310-c to generate another scaled subinterval. The communication device may update the residual length and the residual energy in accordance with Equation 23 and 24, respectively. That is, the residual energy may be represented as n₃=n₂−kₘ₋₂ and the residual energy may be represented as E₃=E₂−kₘ₋₂E (aₘ₋₂).

In some examples, the first stage of the two-stage encoding operation may (e.g., effectively) consider a partitioning of the set of symbol sequences [symbol] (m, n, Ē). For example, for an iteration j, in which 0≤j≤m−2, a subset of symbol sequences in the set of symbol sequences [symbol] (m, n, Ē) may be represented as {kₘ₋ⱼ₊₁, . . . , kₘ; m, n, Ē}, such that the number of occurrences of symbol aᵢ for each such symbol sequence (e.g., included in in the set of symbol sequences {kₘ₋ⱼ₊₁, . . . , kₘ; m, n, Ē}) may be equal to kᵢ (e.g., for all i ∈{m−j+1, . . . , m}. That is, iteration j may correspond to the set {k*ₘ₋ⱼ₊₁, . . . , kₘ;m, n, Ē} and at the beginning of iteration j, the elements k*ₘ₋ⱼ₊₁, . . . , k*ₘ of the composition k* may have been determined (e.g., sequentially during the first j−1 iterations). As such, the partitioning of the set {kₘ₋ⱼ₊₁, . . . , k*ₕᵤ; m, n, Ē} may be based on kₘ₋ⱼ. (e.g., an integer within the range represented in accordance with Equation 20). For example, the set {kₘ₋ⱼ₊₁, . . . , kₘ; m, n, Ē} may be represented in accordance with the following Equation 26:

$$\{ {k}_{m - j + 1}^{*} , … , {k}_{m}^{*} ; m , n , \overline{E} \} = {⋃}_{{k}_{m - j}} \{ {k}_{m - j} , {k}_{m - j + 1}^{*} , … , {k}_{m}^{*} ; m , n , \overline{E} \} . \qquad ( 26 )$$

In such an example, a ratio of the cardinality of {kₘ₋ⱼ, k*ₘ₋ⱼ₊₁, . . . , k*ₘ; m, n, Ē} over that of {k*ₘ₋ⱼ₊₁, . . . , kₘ; m, n, Ē} may be represented as p (kₘ₋ⱼ|m−j, nⱼ, Eⱼ), such as to satisfy the following Equation 27:

$$\frac{\vert \{ {k}_{m - j} , {k}_{m - j + 1}^{*} , … , {k}_{m}^{*} ; m , n , \overline{E} \} \vert}{\vert \{ {k}_{m - j + 1}^{*} , … , {k}_{m}^{*} ; m , n , \overline{E} \} \vert} = \frac{( \begin{matrix}{n}_{j} \\ {k}_{m - j}\end{matrix} ) {N}_{c}^{[ m - j - 1 ]} ( {n}_{j} - {k}_{m - j} , {E}_{j} - {k}_{m - j} E ( {a}_{m - j} ) )}{{N}_{c}^{[ m - j ]} ( {n}_{j} , {E}_{j} )} . \qquad ( 27 )$$

For example, the interval 305 (e.g., that may be represented as [0, 1)) may correspond to a set {m, n, Ē} (e.g., the set of the set of symbol sequences [symbol] (m, n, Ē)). That is, the interval 305 (e.g., a unit interval) may correspond to the set {m, n, Ē}, which may be a set of symbol sequences (e.g., that may each satisfy the properties (e.g., parameters) m, n, Ē. For example, each element of each symbol sequence associated with the set {m, n, Ē} may be included in (e.g., belong to) the alphabet [symbol] ₘ, each symbol sequence associated with the set {m, n, Ē} may have a length equal to n, and each symbol sequence associated with the set {m, n, Ē} may have an energy less than or equal to Ē.

Additionally, or alternatively, the interval 305 corresponding to the set {m, n, Ē} may be partitioned to obtain the subinterval 310-a, which may correspond to a subset of the set {m, n, Ē}. For example, the first transition (e.g., identified using the first number x and the multiple subintervals within the interval 305) may correspond to the subinterval 310-a. In such an example, the subinterval 310-a may correspond to a first subset {k*ₘ; m, n, Ē} of the set {m, n, Ē}, in which a quantity of occurrences of a symbol aₘ of the alphabet [symbol] ₘ within each symbol sequence of the first subset of symbol sequences (e.g., the subset {k*ₘ; m, n, Ē}) may be equal to the element (k*ₘ) of the composition k* (e.g., determined via the selection of the first transition). That is, each subinterval of the interval 305 (e.g., including the subinterval 310-a) may corresponds to a respective subset (e.g., the subinterval 310-a may correspond to the subset {kₘ; m, n, Ē}) and partitioning of the interval 305 (e.g., the unit interval [0,1)) may corresponds to a disjoint union property. For example, the set {m, n, Ē} may be represented in accordance with the following Equation 28:

$$\{ m , n , \overline{E} \} = {⋃}_{{k}_{m}} \{ {k}_{m} ; m , n , \overline{E} \} . \qquad ( 28 )$$

Additionally, or alternatively, the scaled subinterval 306-a corresponding to the subset {k*ₘ; m, n, Ē} may be partitioned to obtain another subinterval (e.g., the subinterval 310-b) that corresponds to a subset of the subset {k*ₘ; m, n, Ē}. For example, the communication device may obtain a subinterval 310-b based on the second number x₁ (e.g., determined during the first iteration, the iteration j=0) and the multiple subintervals (e.g., of the scaled subinterval 306-a). In such an example, the subinterval 310-b may correspond to a second subset {k*ₘ₋₁, k*ₘ; m, n, Ē} of the subset {k*ₘ; m, n, Ē}, in which a quantity of occurrences of the symbol aₘ of the alphabet [symbol] ₘ within each symbol sequence of the second subset of symbol sequences (e.g., the subset {k*ₘ₋₁, k); m, n, Ē}) may be equal to the element (k*ₘ) of the composition k* (e.g., determined via the selection of the first transition) and a quantity of occurrences of a symbol aₘ₋₁ of the alphabet [symbol] ₘ within each symbol sequence of the second subset of symbol sequences may be equal to the element (k*ₘ₋₁) of the composition k* (e.g., determined via the selection of the second transition).

In some examples, iterations j=0 through j=m−2 of the first stage may sequentially determine k*ₘ, k*ₘ₋₁, . . . , k*₂, which may specify the number of occurrences of the symbols aₘ, aₘ₋₁, . . . , a₂ that will appear in the output sequence(s), respectively. In such an example, during an iteration j=m−1 (e.g., a relatively last iteration), the communication device may determine an element (k*₁) of the composition k*. For example, during the iteration j=m−1, the element k*₁ of k* (e.g., the first element) may be determined by n−Eᵢ₌₂^{m}k*ᵢ, where n may be the output sequence length. In some examples, a quantity of iterations (e.g., including the relatively last iteration in which the element k*₁ may be determined) included in the first stage may be based on (e.g., equal to) a value of m (e.g., a quantity of elements included in the alphabet [symbol] ₘ). In some examples, m may have a value greater than or equal to about 2.

In some examples, a value N_{c}^{[m]}(n, [symbol] ) for general m, n and [symbol] used in the first stage of encoding may be accessed via computing (e.g., directly, such as using a recursive definition), via referencing a look-up table that may store such values, or via an approximation method, in which case the approximate value may be denoted as [symbol] ^{[m]}(n, [symbol] ) using a ‘hat’ notation, or any combination thereof. In such examples, m may correspond to an integer such that 1≤m≤m. Additionally or alternatively, n may correspond to a non-negative integer that may be less than or equal to n and [symbol] may correspond to a non-negative integer less than or equal to Ē. That is, the first stage of encoding may include computing (or approximating) transition probabilities, in which N_{c}^{[m]}(n, [symbol] ) may depend on multiple values of m, n, [symbol] . In other words, m, n, [symbol] may correspond to variables of N_{c}.

In some examples (e.g., if the value N_{c}^{[m]}(n, [symbol] ) may be approximated using an approximation method), the first stage of the two-stage encoding operation may include compute ratios (e.g., transition probabilities) using approximate values. For example, a transition probability p (·|m−j, nⱼ, Eⱼ) may be approximated in accordance with the following Equation 29:

$$\hat{p} ( {k}_{m - j} \vert m - j , {n}_{j} , {E}_{j} ) {=}^{△} \frac{( \begin{matrix}{n}_{j} \\ {k}_{m - j}\end{matrix} ) {\hat{N}}_{c}^{[ m - j - 1 ]} ( {n}_{j} - {k}_{m - j} , {E}_{j} - {k}_{m - j} E ( {a}_{m - j} ) )}{{\sum }_{κ ∈ [ {\underline{k}}_{m - j} , {\overline{k}}_{m - j} ]} ( \begin{matrix}{n}_{j} \\ κ\end{matrix} ) {\hat{N}}_{c}^{[ m - j - 1 ]} ( {n}_{j} - κ , {E}_{j} - κ E ( {a}_{m - j} ) )} \qquad ( 29 )$$

In accordance with Equation 29 (e.g., the above formula), kₘ₋ⱼ and k̅ₘ₋ⱼ may correspond to integers that may depend on nⱼ and Eⱼ and that may be used to specify a range of kₘ₋ⱼ. In some examples, binomial coefficients included in Equation 29 (e.g., the above formula) may be accessed via computing, via approximating, or via a look-up table, or any combination thereof. In some examples, a same accessing method may be applied for decoding. Additionally, or alternatively, a relatively last scaled xₘ₋₁ of the first stage of the two-stage encoding operation may be used as an initialization for a second stage of the two-stage encoding operation.

In some examples of encoding of direct peeling, as described herein, a second stage (e.g., a second stage of the two-stage encoding operation) may be used to determine the symbols of the output sequence(s) based on the composition k* and the output from the first stage (e.g., stage 1). In some examples, the symbols of the output sequence(s) may be determined sequentially in n iterations. That is, in each iteration of the second stage, an element (e.g., a single element) of s may be determined. In some examples, determining an element of s may include (e.g., involve) computing ratios based on the composition k* and a composition of a prefix (e.g., of the output sequence) determined up to an iteration (e.g., a current iteration). Additionally, or alternatively, determining an element of the output sequence(s) may include a scaling operation associated with x, an update of the prefix, and an update of the composition of the prefix. In some examples, the second stage may leverage one or more encoding algorithms of constant composition distribution matching (CCDM).

For example, the second stage of the two-stage encoding operation may initializes t=0, k₀=0=(0, 0, . . . , 0) ∈ [symbol] ^{m}, and z₀=xₘ₋₁. Additionally, or alternatively, the second stage of the two-stage encoding operation may include a quantity of iterations such that (e.g., and including) t=n−1. For example, for each possible i ∈{1, 2, . . . , m}, the communication device may compute the ratio (e.g., the transition probability) in accordance with the following Equation 30:

$$p ( {k}_{t} \to {k}_{t} + {e}_{i} ) {=}^{△} \frac{{k}_{i} ( {k}^{*} ) - {k}_{i} ( {k}_{t} )}{n - t} \qquad ( 30 )$$

if kᵢ(k*)≥kᵢ(kₜ). In accordance with Equation 30, kᵢ (k*) may correspond to the i-th element of k* and kᵢ (kₜ) may correspond to the i-th element of kₜ. In some other examples (e.g., if kᵢ(k*)<kᵢ (kₜ)), the ratio (e.g., the transition probability) may be equal to zero. That is, the transition probably may be determined in accordance with the following Equation 31:

$$p ( {k}_{t} \to {k}_{t} + {e}_{i} ) = 0 \qquad ( 31 )$$

In some examples, the index j=jₜ₊₁ ∈{1, 2, . . . , m} may be determined, such as to satisfy the following Equation 32:

$${z}_{t} ∈ [ {\sum }_{i = 1}^{j - 1} p ( {k}_{t} \to {k}_{t} + {e}_{i} ) , {\sum }_{i = 1}^{j} p ( {k}_{t} \to {k}_{t} + {e}_{i} ) ) . \qquad ( 32 )$$

Additionally, or alternatively, the output symbol sₜ₊₁ may be determined through setting sₜ₊₁=aⱼ) and scaling zₜ to zₜ₊₁ in accordance with the following Equation 33:

$${z}_{t + 1} = \frac{{z}_{t} - {\sum }_{i = 1}^{j - 1} p ( {k}_{t} \to {k}_{t} + {e}_{i} )}{p ( {k}_{t} \to {k}_{t} + {e}_{i} )} . \qquad ( 33 )$$

The communication device may update the prefix composition (kₜ₊₁=kₜ+eᵢ) and increase the value of t by 1 (e.g., may add 1 to the value of t) which may complete iteration t. In some examples, the communication device may transmit the output symbol sequence(s) to another communications device (e.g., a receiving device) using a wireless medium.

The receiving device may obtain the symbol sequence(s) and perform a two-stage decoding operation (e.g., decoding of the direct peeling). That is, an input available for the two-stage decoding operation (e.g., the decoding of direct peeling) may include a length-n symbol sequence s=(s₁, s₂, . . . , sₙ) encoded by direct peeling (e.g., the symbol sequence transmitted from the communication device and obtained at the receiving device). In some examples, the sequence(s) may have a length (e.g., a quantity of symbols) equal to n, energy that may be less than or equal to (e.g., at most) Ē, and each element of(s) may be from the symbol alphabet [symbol] ₘ. For example, the symbol sequence may belong to a set of symbol sequence ( [symbol] (m, n, Ē)) that may have a length n, be generated using (e.g., may be over) the alphabet [symbol] ₘ, and each sequence of [symbol] (m, n, Ē) may have an energy that may be less than or equal to (e.g., may be at most equal to, fails to exceed) Ē. In some examples, m may be a positive integer and n and Ē may be nonnegative integers.

Additionally, or alternatively, for the symbol alphabet with a cardinality m (e.g., [symbol] ₘ={a₁, a₂, . . . , aₘ}), each symbol (aᵢ) may have an energy E (aᵢ). Additionally, or alternatively, the alphabet [symbol] ₘ and the threshold energy E may be available (e.g., to the receiving device) for decoding. In some examples, an output of the two-stage decoding operation may include a bit sequence. For example, the decoding of direct peeling (e.g., using the two-stage decoding operation) may map the symbol sequence(s) to a length-k bit sequence (û₁, Û₂, . . . , Ûₖ), which may be an estimate of an information bit sequence (e.g., the k-bit sequence (u₁, u₂, . . . , uₖ) used to encode the symbol sequence using the two-stage encoding operation). In such an example, the receiving device may select a value of k, such as to satisfy a same one or more conditions as used to select k during the two-stage encoding operation and, as such, may enable decodability. That is, a selection of k may satisfy the same condition as encoding (e.g., at the communication device) and thus enable decodability (e.g., unique decodability) at the receiving device.

In some examples, in a first stage (e.g., phase) of the two-stage decoding operation, the receiving device may determine (e.g., form) refined estimates (e.g., represented as xⱼ and x̅ⱼ) of information bits (e.g., included in the symbol sequence(s)) based on a composition k* of the symbol sequence(s). In some examples, determining the refined estimates may include (e.g., involve) computing the composition k* of the obtained (e.g., received) sequence s=(s₁, s₂, . . . , sₙ). The composition k* may be determined (e.g., the refined estimated may be obtained) sequentially, for example in m−1 iterations.

In some examples, each iteration (e.g., of the m−1 iterations) may include obtaining (e.g., accessing via computing, approximating, or using a look-up table) multiple N_{c} cumulative sequence quantities and binomial coefficients. Additionally, or alternatively, each iteration may include computing ratios (e.g., transition probabilities) based on the N_{c} cumulative sequence quantities and binomial coefficients, such that each such ratio may be proportional to a product of an N_{c} cumulative sequence quantity and a binomial coefficient. In some examples, each iteration may include obtaining subsequent (e.g., new) refined estimates (xⱼ₊₁ and x̅ⱼ₊₁) from previous refined estimates (xⱼ and x̅ⱼ). Additionally, or alternatively, each iteration may include determining an update of a residual length and a residual energy (e.g., a residual of the maximum energy or a residual of an otherwise suitable energy).

In some examples, the first stage of the two-stage decoding operation may include a quantity of iterations (e.g., j=0 through j=m−2), and during each iteration the receiving device may determine an element (k*ₜ) of the composition k*. For example, during each iteration (j), the receiving device may determine an element (k*ᵢ) in accordance with the following Equation 34:

$${k}_{m - j}^{*} = \vert \{ i \vert 1 \leq i \leq n , {s}_{i} = {a}_{m - j} \} \vert . \qquad ( 34 )$$

The receiving device may compute one or more ratios (e.g., transition probabilities represented as p (·|m−j, nⱼ, Eⱼ)) in accordance with the following Equation 35:

$$p ( {k}_{m - j} \vert m - j , {n}_{j} , {E}_{j} ) {=}^{△} \frac{( \begin{matrix}{n}_{j} \\ {k}_{m - j}\end{matrix} ) {N}_{c}^{[ m - j - 1 ]} ( {n}_{j} - {k}_{m - j} , {E}_{j} - {k}_{m - j} E ( {a}_{m - j} ) )}{{N}_{c}^{[ m - j ]} ( {n}_{j} , {E}_{j} )} \qquad ( 35 )$$

where kₘ₋ⱼ correspond to an integer (e.g., a non-negative integer) within a range represented in accordance with the following Equation 36:

$$0 \leq {k}_{m - j} \leq {k}_{m - j}^{*} . \qquad ( 36 )$$

In such an example, the receiving device may update xⱼ to xⱼ₊₁ in accordance with the following Equation 37:

$${\underline{x}}_{j + 1} = {\underline{x}}_{j} + ( {\overline{x}}_{j} - {\underline{x}}_{j} ) {\sum }_{κ = 0}^{{k}_{m - j}^{*} - 1} p ( κ \vert m - j , {n}_{j} , {E}_{j} ) \qquad ( 37 )$$

and x̅ⱼ to and X̅ⱼ₊₁ in accordance with Equation 38:

$${\overline{x}}_{j + 1} = {\underline{x}}_{j} + ( {\overline{x}}_{j} - {\underline{x}}_{j} ) {\sum }_{κ = 0}^{{k}_{m - j}^{*}} p ( κ \vert m - j , {n}_{j} , {E}_{j} ) \qquad ( 38 )$$

The receiving device may compute the residual length (nⱼ₊₁=nⱼ−kₘ₋ⱼ) and the residual energy (Eⱼ₊₁=Eⱼ−kₘ₋ⱼ E(aₘ₋ⱼ)) and may increase j by 1, which may complete (e.g., end) iteration j.

In some examples, in a second stage (e.g., phase) of the two-stage decoding operation, the receiving device may determine (e.g., form) an estimate (e.g., a final estimate), represented as (û₁, û₂, . . . , ûₖ), of the information bits. The estimate of the information bits may be determined sequentially, for example in n iterations. For example, the estimate may be based on the composition k* and the refined estimates xₘ₋₁ and x̅ₘ₋₁ from the first stage of decoding. In some examples, the second stage of the two-stage decoding operation may leverage one or more decoding algorithms of CCDM to estimate the information bits.

For example, in the second stage (e.g., phase) of the two-stage decoding operation the receiving device may initialize t=0, z₀=xₘ₋₁, and Z̅₀=X̅ₘ₋₁ and use the composition k*=(k*₁, . . . , k*ₘ) to compute the ratios (e.g., transition probabilities). In some examples, the second stage of the two-stage decoding operation may include a quantity of iterations (e.g., t=0 through t=n−1), and during each iteration the receiving device may computes one or more ratios (e.g., transition probabilities). For example, for each possible i ∈{1, 2, . . . , m}, the receiving device may compute the ratio in accordance with the following Equation 39:

$$p ( {k}_{t} \to {k}_{t} + {e}_{i} ) {=}^{△} \frac{{k}_{i} ( {k}^{*} ) - {k}_{i} ( {k}_{t} )}{n - t} \qquad ( 39 )$$

if kᵢ (k*)>kᵢ (kₜ). In accordance with Equation 39, the parameter kᵢ (k*) may correspond to the i-th element of k* and kᵢ (kₜ) may correspond to the i-th element of kₜ. In some other examples (e.g., if kᵢ (k*)<kᵢ (kₜ)), the ratio (e.g., the transition probability) may be equal to zero. That is, the transition probably may be determined in accordance with the following Equation 40:

$$p ( {k}_{t} \to {k}_{t} + {e}_{i} ) = 0 . \qquad ( 40 )$$

In some examples, the index j=jₜ₊₁ ∈{1, 2, . . . , m} may be determined, such that aⱼ=sₜ₊₁. That is, the index j may be determined such that the symbol sₜ₊₁ in the received symbol sequence(s) may correspond to the symbol aⱼ. Additionally, or alternatively, the receiving device may update zⱼ to zⱼ₊₁ in accordance with the following Equation 41:

$${\underline{z}}_{t + 1} = {{z}_{-}}_{t} + ( {\overline{z}}_{t} - {\underline{z}}_{t} ) {\sum }_{i = 1}^{j - 1} p ( {k}_{t} \to {k}_{t} + {e}_{i} ) \qquad ( 41 )$$

and may update Z̅ⱼ to Z̅ⱼ₊₁ in accordance with the following Equation 42:

$${\overline{z}}_{t + 1} = {\underline{z}}_{t} + ( {\overline{z}}_{t} - {\underline{z}}_{t} ) {\sum }_{i = 1}^{j} p ( {k}_{t} \to {k}_{t} + {e}_{i} ) . \qquad ( 42 )$$

The receiving device may update the prefix composition (kₜ₊₁=kₜ+eᵢ) and may increase t by 1, which may complete (e.g., end) iteration t. In some examples, if Zn is not a dyadic number of the form j2^{-k}, the decoded output (e.g., the output bit sequence (Û₁, Û₂, . . . , ûₖ)) may correspond to k bits (e.g., relatively first k bits) of a binary expansion Z̅ₙ. Additionally, or alternatively, if Zn is a dyadic number of the form j2^{-k} or some other number of some other form, the decoded output (e.g., the output bit sequence (û₁, Û₂, . . . , ûₖ)) may correspond to k bits (e.g., relatively first k bits) of a binary expansion zₙ.

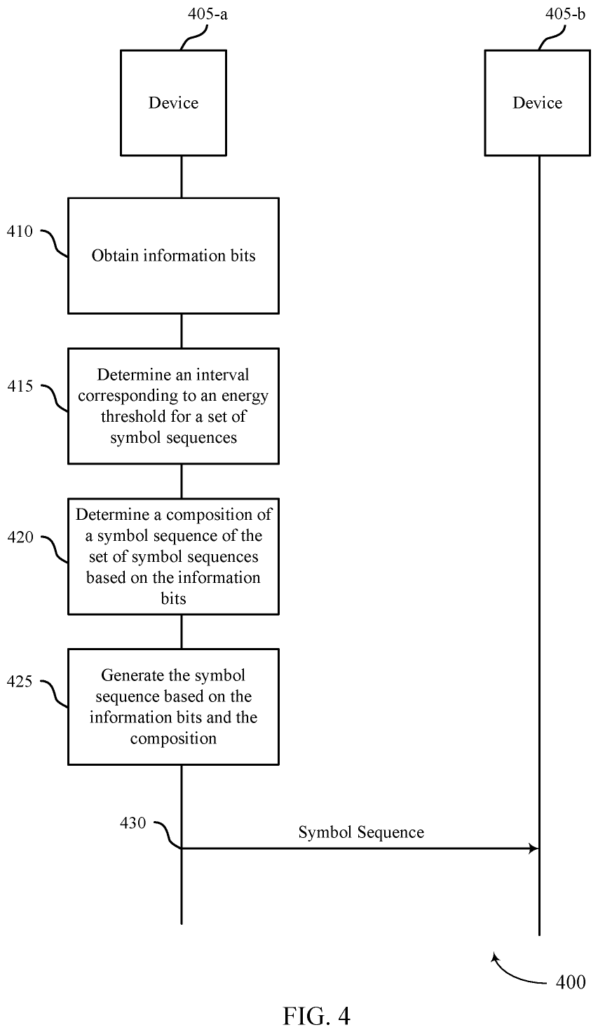

FIG. 4 an example of a process flow 400 that supports techniques for probabilistic shaping using peeling in accordance with one or more aspects of the present disclosure. In some examples, the process flow 400 may implement aspects of the wireless communications system 100, the wireless communications system 200, and the partitioning scheme 300. For example, the process flow 400 may be implemented at a device 405-a and a device 405-b, which may examples of a device as described with reference to FIGS. 1 through 3. In the example of FIG. 4, the device 405-a may be a transmitting device (e.g., an encoding device) and the device 405-b may be a receiving device (e.g., a decoding device).

At 410, the device 405-a may obtain information bits. For example, the device may generate one or more information bits or obtain one or more information bits from one or more other devices, or both. In some examples, the device 405-a may perform a two-stage encoding procedure using the obtained information bits. The two-stage encoding procedure may be an example of a two-stage encoding procedure as described throughout the present disclosure, including with reference to FIG. 3. For example, the two-stage encoding procedure may include two-stage encoding of direct peeling.

At 415, the device 405-a may determine an interval corresponding to an energy threshold for a set of symbol sequences. The interval may be an example of an interval as described throughout the present disclosure, including with reference to FIG. 3. For example, the interval may correspond to a set of symbol sequences (e.g., [symbol] (m, n, E)) that may each satisfy the parameters m, n, Ē. That is, each symbol sequence of the set of symbol sequences may be of a same length (e.g., a length equal to the parameter n) and may have an energy that may be less than or equal to the parameter Ē.

At 420, the device 405-a may determine, in a first stage of the two-stage encoding operation, a composition of a symbol sequence of the set of symbol sequences based on the information bits. The composition may be an example of a composition as described throughout the present disclosure, including with reference to FIG. 3. For example, a first element of the composition may be determined in a first iteration of the first stage of the two-stage encoding operation based on selecting a first transition associated with a first transition probability. In some examples, the first element of the composition may correspond to a quantity of occurrences of a first symbol of an alphabet of symbols ( [symbol] ₘ) used for generating the symbol sequence. Additionally, or alternatively, a first subinterval of the interval may be determined in the first iteration of the first stage of the two-stage encoding operation, such that the first subinterval may correspond to the first transition. For example, a length of the first subinterval may be proportional to the first transition probability.

In some examples, a second element of the composition may be determined in a second iteration of the first stage of the two-stage encoding operation based on selecting a second transition associated with a second transition probability. In such examples, the second element of the composition may correspond to a quantity of occurrences of a second symbol of the alphabet of symbols ( [symbol] ₘ) used for generating the symbol sequence. Additionally, or alternatively, a second subinterval of the interval may be determined in the second iteration of the first stage of the two-stage encoding operation, such that the second subinterval may correspond to the second transition. That is, a length of the second subinterval may be proportional to the second transition probability.

At 425, the device 405-a may generate, in a second stage of the two-stage encoding operation, the symbol sequence based on the information bits and the composition (e.g., determined at 420). In some examples, the symbol sequence may be an example of a symbol sequence as described throughout the present disclosure, including with reference to FIG. 3. For example, an energy of the symbol sequence may be less than or equal to the energy threshold.

At 430, the device 405-a may transmit the symbol sequence to the device 405-b using a wireless medium. For example, the device 405-a may transmit the symbol sequence over-the-air (OTA). In some examples, encoding the information bits using the two-stage encoding procedure may provide for a reduced shaping gap and increased throughput, among other possible benefits.

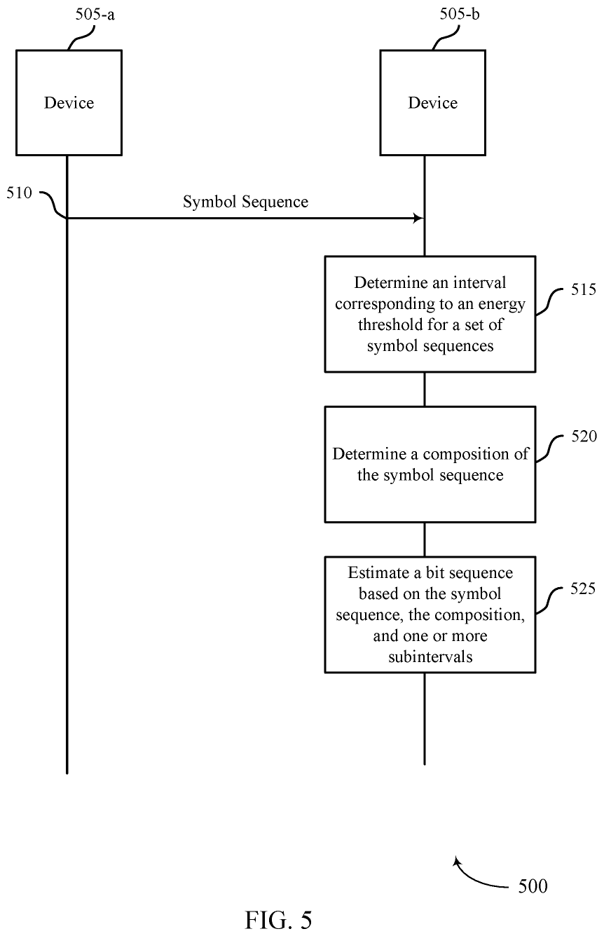

FIG. 5 illustrates an example of a process flow 500 that supports techniques for probabilistic shaping using peeling in accordance with one or more aspects of the present disclosure. In some examples, the process flow 500 may implement aspects of the wireless communications system 100, the wireless communications system 200, the partitioning scheme 300, and the process flow 400. For example, the process flow 500 may be implemented at a device 505-a and a device 505-b, which may be examples of a device as described with reference to FIGS. 1 through 4. In the example of FIG. 5, the device 505-a may be a transmitting device (e.g., an encoding device) and the device 505-b may be a receiving device (e.g., a decoding device).

At 510, the device 505-b may obtain a symbol sequence from the device 505-a. The symbol sequence may be an example of a symbol sequence as described throughout the present disclosure, including with reference to FIGS. 2 through 4. For example, the symbol sequence may be generated using a two-stage encoding procedure. In such an example, the device 505-b may perform a two-stage decoding operation using the symbol sequence. The two-stage decoding procedure may be an example of a two-stage decoding procedure as described throughout the present disclosure, including with reference to FIG. 3. For example, the two-stage decoding procedure may include two-stage decoding of direct peeling.

At 515, the device 505-b may determine an interval corresponding to an energy threshold for a set of symbol sequences. The interval may be an example of an interval as described throughout the present disclosure, including with reference to FIG. 3. For example, the interval may correspond to a set of symbol sequences (e.g., [symbol] (m, n, Ē)) that may include the symbol sequence and may satisfy the parameters m, n, Ē. That is, each symbol sequence of the set of symbol sequences may be of a same length (e.g., a length equal to the parameter n) and have an energy that may be less than or equal to the parameter Ē.

At 520, in a first stage of the two-stage decoding operation, the device 505-b may determine a composition of the symbol sequence. The composition may be an example of a composition as described throughout the present disclosure including with reference to FIG. 3. For example, a first element of the composition may be determined in a first iteration of the first stage of the two-stage decoding operation based on a first quantity of occurrences of a first symbol of an alphabet of symbols ( [symbol] ₘ) used for generating the symbol sequence. Additionally, or alternatively, a first subinterval of the interval may be determined in the first iteration of the first stage of the two-stage decoding operation based on determining the first element of the composition and a first set of multiple transition probabilities.

In some examples, a second element of the composition may be determined in a second iteration of the first stage of the two-stage decoding operation based on a second quantity of occurrences of a second symbol of the alphabet of symbols ( [symbol] ₘ) used for generating the symbol sequence. Additionally, or alternatively, a second subinterval of the interval may be determined in the second iteration of the first stage of the two-stage decoding operation based on determining the second element of the composition and a second set of multiple transition probabilities.

At 525, in a second stage of the two-stage decoding operation, the device 505-b may estimate a bit sequence based on the symbol sequence, the composition, and one or more subintervals (e.g., the second subinterval or one or more other subintervals subsequent to the second subinterval). For example, the second stage of the two-stage decoding operation may use (e.g., as partial input) a relatively last obtained subinterval from the first stage of the two-stage decoding operation, and use the relatively last obtained subinterval to obtain another subinterval from which an estimate of the bit sequence may be generated (e.g., obtained, formed). In some examples, decoding the symbol sequence using the two-stage decoding procedure may provide for increased reliability of communications between the device 505-a and the device 505-b, among other possible benefits.

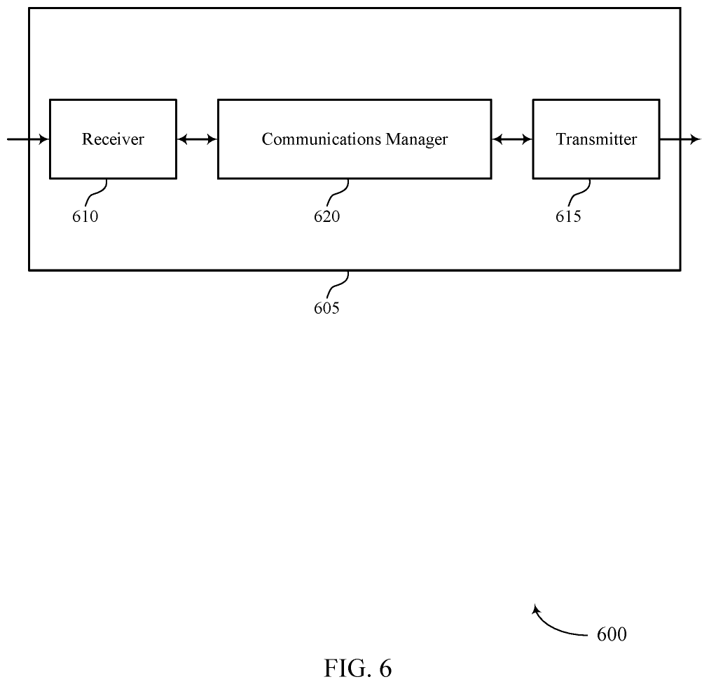

FIG. 6 shows a block diagram 600 of a device 605 that supports techniques for probabilistic shaping using peeling in accordance with one or more aspects of the present disclosure. The device 605 may be an example of aspects of a UE 115 or a network entity 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for probabilistic shaping using peeling). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for probabilistic shaping using peeling). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for probabilistic shaping using peeling as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first device (e.g., the device 605) in accordance with examples as disclosed herein. For example, the communications manager 620 may be configured as or otherwise support a means for obtaining a set of multiple information bits. The communications manager 620 may be configured as or otherwise support a means for performing a two-stage encoding operation using the set of multiple information bits. The two-stage encoding operation includes determining an interval corresponding to an energy threshold for a set of symbol sequences, each symbol sequence of the set of symbol sequences being of a same length. The two-stage encoding operation also includes determining, in a first stage of the two-stage encoding operation, a composition of a symbol sequence of the set of symbol sequences based on the set of multiple information bits, where a first element of the composition is determined in a first iteration of the first stage of the two-stage encoding operation based on selecting a first transition associated with a first transition probability, the first element of the composition corresponding to a quantity of occurrences of a first symbol of an alphabet of symbols used for generating the symbol sequence, a first subinterval of the interval is determined, the first subinterval corresponding to the first transition, a second element of the composition is determined in a second iteration of the first stage of the two-stage encoding operation based on selecting a second transition associated with a second transition probability, the second element of the composition corresponding to a quantity of occurrences of a second symbol of the alphabet of symbols used for generating the symbol sequence, and a second subinterval of the interval is determined, the second subinterval corresponding to the second transition. The communications manager 620 may be configured as or otherwise support a means for generating, in a second stage of the two-stage encoding operation, the symbol sequence based on the set of multiple information bits and the composition, where an energy of the symbol sequence is less than or equal to the energy threshold. The communications manager 620 may be configured as or otherwise support a means for transmitting the symbol sequence to a second device (e.g., another device 605) using a wireless medium.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced power consumption, and more efficient utilization of communication resources.

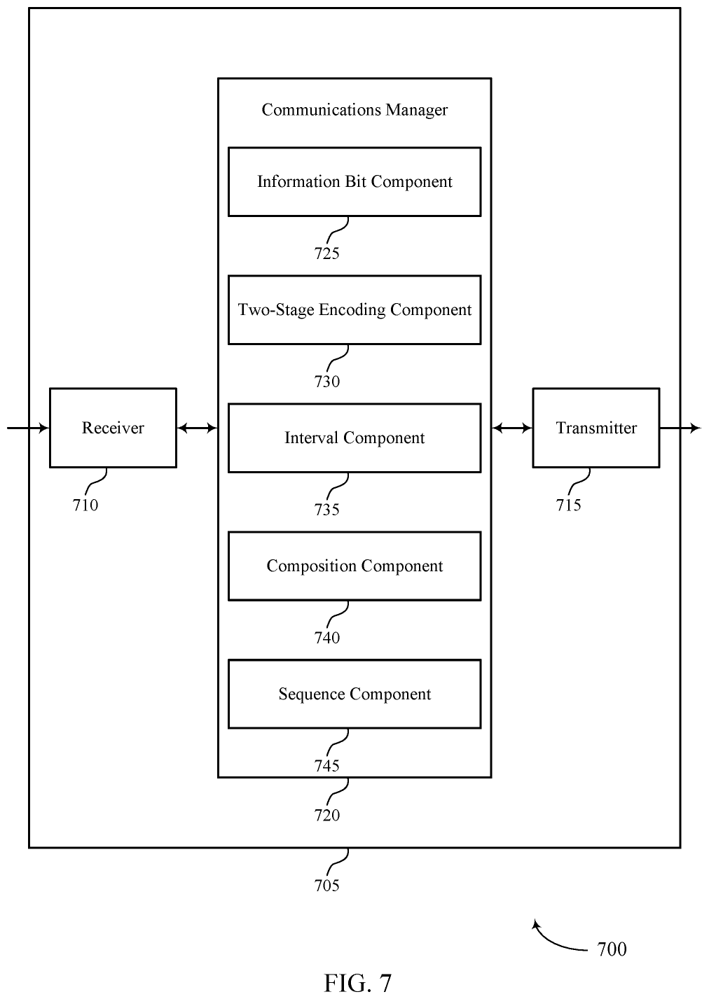

FIG. 7 shows a block diagram 700 of a device 705 that supports techniques for probabilistic shaping using peeling in accordance with one or more aspects of the present disclosure. The device 705 may be an example of aspects of a device 605 or a UE 115 or a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for probabilistic shaping using peeling). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for probabilistic shaping using peeling). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for probabilistic shaping using peeling as described herein. For example, the communications manager 720 may include an information bit component 725, a two-stage encoding component 730, an interval component 735, a composition component 740, a sequence component 745, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first device (e.g., the device 705) in accordance with examples as disclosed herein. The information bit component 725 may be configured as or otherwise support a means for obtaining a set of multiple information bits. The two-stage encoding component 730 may be configured as or otherwise support a means for performing a two-stage encoding operation using the set of multiple information bits, the two-stage encoding operation includes determining an interval corresponding to an energy threshold for a set of symbol sequences, each symbol sequence of the set of symbol sequences being of a same length. The two-stage encoding operation also includes determining, in a first stage of the two-stage encoding operation, a composition of a symbol sequence of the set of symbol sequences based on the set of multiple information bits, where a first element of the composition is determined in a first iteration of the first stage of the two-stage encoding operation based on selecting a first transition associated with a first transition probability, the first element of the composition corresponding to a quantity of occurrences of a first symbol of an alphabet of symbols used for generating the symbol sequence, a first subinterval of the interval is determined, the first subinterval corresponding to the first transition, a second element of the composition is determined in a second iteration of the first stage of the two-stage encoding operation based on selecting a second transition associated with a second transition probability, the second element of the composition corresponding to a quantity of occurrences of a second symbol of the alphabet of symbols used for generating the symbol sequence, and a second subinterval of the interval is determined, the second subinterval corresponding to the second transition. The sequence component 745 may be configured as or otherwise support a means for generating, in a second stage of the two-stage encoding operation, the symbol sequence based on the set of multiple information bits and the composition, where an energy of the symbol sequence is less than or equal to the energy threshold. The sequence component 745 may be configured as or otherwise support a means for transmitting the symbol sequence to a second device (e.g., another device 705) using a wireless medium.

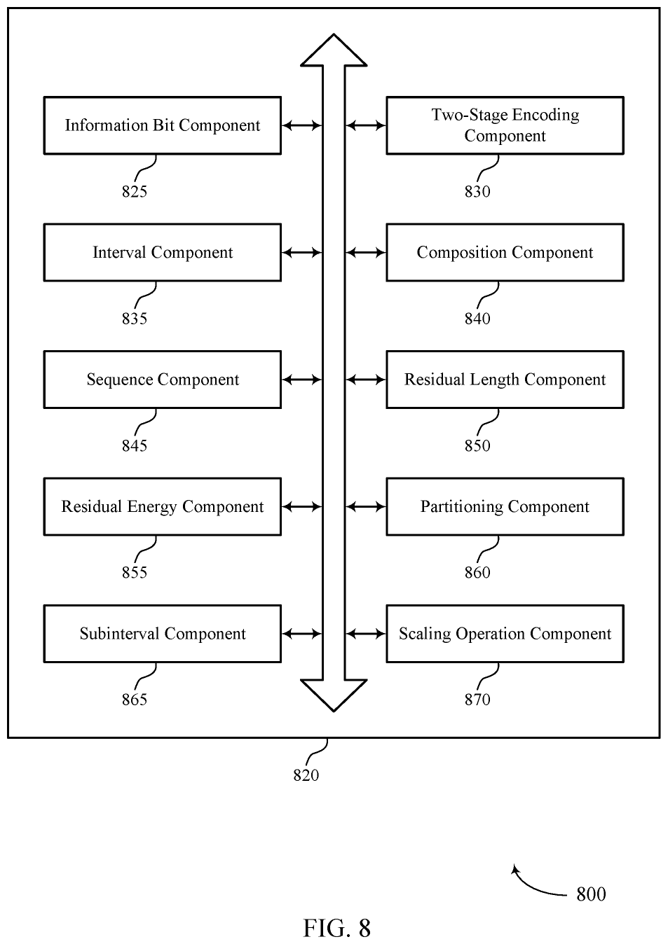

FIG. 8 shows a block diagram 800 of a communications manager 820 that supports techniques for probabilistic shaping using peeling in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for probabilistic shaping using peeling as described herein. For example, the communications manager 820 may include an information bit component 825, a two-stage encoding component 830, an interval component 835, a composition component 840, a sequence component 845, a residual length component 850, a residual energy component 855, a partitioning component 860, a subinterval component 865, a scaling operation component 870, or any combination thereof. Each of these components may communicate, directly or indirectly, with one another (e.g., via one or more buses).

The communications manager 820 may support wireless communication at a first device (e.g., a UE, a network entity) in accordance with examples as disclosed herein. The information bit component 825 may be configured as or otherwise support a means for obtaining a set of multiple information bits. The two-stage encoding component 830 may be configured as or otherwise support a means for performing a two-stage encoding operation using the set of multiple information bits, the two-stage encoding operation includes determining an interval corresponding to an energy threshold for a set of symbol sequences, each symbol sequence of the set of symbol sequences being of a same length. The two-stage encoding operation also includes determining, in a first stage of the two-stage encoding operation, a composition of a symbol sequence of the set of symbol sequences based on the set of multiple information bits, where a first element of the composition is determined in a first iteration of the first stage of the two-stage encoding operation based on selecting a first transition associated with a first transition probability, the first element of the composition corresponding to a quantity of occurrences of a first symbol of an alphabet of symbols used for generating the symbol sequence, a first subinterval of the interval is determined, the first subinterval corresponding to the first transition, a second element of the composition is determined in a second iteration of the first stage of the two-stage encoding operation based on selecting a second transition associated with a second transition probability, the second element of the composition corresponding to a quantity of occurrences of a second symbol of the alphabet of symbols used for generating the symbol sequence, and a second subinterval of the interval is determined, the second subinterval corresponding to the second transition. The sequence component 845 may be configured as or otherwise support a means for generating, in a second stage of the two-stage encoding operation, the symbol sequence based on the set of multiple information bits and the composition, where an energy of the symbol sequence is less than or equal to the energy threshold. In some examples, the sequence component 845 may be configured as or otherwise support a means for transmitting the symbol sequence to a second device (e.g., another UE, another network entity) using a wireless medium.

In some examples, to support determining the composition of the symbol sequence, the composition component 840 may be configured as or otherwise support a means for determining a first number based on the set of multiple information bits and the energy threshold. In some examples, to support determining the composition of the symbol sequence, the composition component 840 may be configured as or otherwise support a means for identifying a first set of nonnegative integers, where each integer includes a first candidate element associated with the first element of the composition. In some examples, to support determining the composition of the symbol sequence, the composition component 840 may be configured as or otherwise support a means for determining a first set of multiple cumulative sequence quantities, where a first cumulative sequence quantity of the first set of multiple cumulative sequence quantities corresponds to a first cardinality of a respective first set of sequences of a first set of multiple sets of sequences generated using a first portion of the alphabet of symbols, a first length of each sequence of the respective first set of sequences of the first set of multiple sets of sequences corresponds to a first difference between a length of the symbol sequence and a first nonnegative integer of the first set of nonnegative integers, and a first energy of each sequence of the respective first set of sequences of the first set of multiple sets of sequences is less than or equal to a second difference between the energy threshold and a product of the first nonnegative integer of the first set of nonnegative integers and an energy of the first symbol. In some examples, to support determining the composition of the symbol sequence, the composition component 840 may be configured as or otherwise support a means for determining a first set of multiple binomial coefficients. In some examples, to support determining the composition of the symbol sequence, the composition component 840 may be configured as or otherwise support a means for determining a first set of multiple transition probabilities based at least on the first set of multiple cumulative sequence quantities and the first set of multiple binomial coefficients. In some examples, to support determining the composition of the symbol sequence, the composition component 840 may be configured as or otherwise support a means for identifying that the first number corresponds to the first transition probability from the first set of multiple transition probabilities, where determining the first element of the composition is based on the identifying. In some examples, to support determining the composition of the symbol sequence, the composition component 840 may be configured as or otherwise support a means for performing a first scaling operation on the first number based on determining the first element of the composition and the first set of multiple transition probabilities, where a second number is generated based on the first scaling operation.

In some examples, the residual length component 850 may be configured as or otherwise support a means for determining a residual length, the residual length being equal to a difference between the length of the symbol sequence and the first element of the composition. In some examples, the residual energy component 855 may be configured as or otherwise support a means for determining a residual energy, the residual energy being equal to a difference between the energy threshold and a product of the first element of the composition and the energy of the first symbol.

In some examples, the composition component 840 may be configured as or otherwise support a means for identifying a second set of nonnegative integers, where each nonnegative integer of the second set of nonnegative integers includes a second candidate element associated with the second element of the composition. In some examples, the composition component 840 may be configured as or otherwise support a means for determining a second set of multiple cumulative sequence quantities, where a second cumulative sequence quantity of the second set of multiple cumulative sequence quantities corresponds to a second cardinality of a respective second set of sequences of a second set of multiple sets of sequences generated using a second portion of the alphabet of symbol sequences, a second length of each sequence of the respective second set of sequences of the second set of multiple sets of sequences corresponds to a third difference between the residual length and a second nonnegative integer of the second set of nonnegative integers, and a second energy of each sequence of the respective second set of sequences of the second set of multiple sets of sequences is less than or equal to a fourth difference between the residual energy and a product of the second nonnegative integer and an energy of the second symbol. In some examples, the composition component 840 may be configured as or otherwise support a means for determining a second set of multiple binomial coefficients. In some examples, the composition component 840 may be configured as or otherwise support a means for determining a second set of multiple transition probabilities based at least on the second set of multiple cumulative sequence quantities and the second set of multiple binomial coefficients. In some examples, the composition component 840 may be configured as or otherwise support a means for identifying that the second number corresponds to the second transition probability from the second set of multiple transition probabilities, where determining the second element of the composition is based on the identifying. In some examples, the composition component 840 may be configured as or otherwise support a means for performing a second scaling operation on the second number based on determining the second element of the composition and the second set of multiple transition probabilities, where a third number is generated based on the second scaling operation.

In some examples, each transition probability of the second set of multiple transition probabilities corresponds to a respective nonnegative integer of the second set of nonnegative integers. In some examples, the second set of multiple transition probabilities includes a first quantity of transition probabilities equal to a second quantity of nonnegative integers included in the second set of nonnegative integers.

In some examples, each transition probability of the first set of multiple transition probabilities corresponds to a respective nonnegative integer of the first set of nonnegative integers. In some examples, the first set of multiple transition probabilities includes a first quantity of transition probabilities equal to a second quantity of nonnegative integers included in the first set of nonnegative integers.

In some examples, the partitioning component 860 may be configured as or otherwise support a means for partitioning the interval into a first set of multiple subintervals in the first iteration of the first stage of the two-stage encoding operation based on the first set of multiple transition probabilities, where a respective length of each subinterval of the first set of multiple subintervals is proportional to a respective transition probability of the first set of multiple transition probabilities. In some examples, the subinterval component 865 may be configured as or otherwise support a means for identifying the first subinterval based on the first number and the first set of multiple subintervals. In some examples, the scaling operation component 870 may be configured as or otherwise support a means for performing a scaling operation on the first subinterval based on the identifying.

In some examples, the partitioning component 860 may be configured as or otherwise support a means for partitioning the first subinterval in the second iteration of the first stage of the two-stage encoding operation into a second set of multiple subintervals, where a respective length of each subinterval of the second set of multiple subintervals is proportional to a respective transition probability of a second set of multiple transition probabilities. In some examples, the subinterval component 865 may be configured as or otherwise support a means for identifying the second subinterval based on the second number and the second set of multiple subintervals.

In some examples, the two-stage encoding operation includes amplitude shaping. In some examples, the first symbol and the second symbol each include an amplitude symbol. In some examples, the first stage includes a set of multiple iterations including at least the first iteration and the second iteration. In some examples, the set of multiple iterations is based on a cardinality of the alphabet.

In some examples, the composition includes a set of multiple elements including at least the first element and the second element. In some examples, the set of multiple elements is based on a cardinality of the alphabet. In some examples, each element of the set of multiple elements includes a nonnegative integer.

In some examples, the first subinterval corresponds to a first subset of symbol sequences of the set of symbol sequences and the second subinterval corresponds to a second subset of symbol sequences of the first subset of symbol sequences.

In some examples, the first element of the composition determined in the first iteration corresponds to a same quantity of occurrences of the first symbol of the alphabet of symbols within each symbol sequence of the first subset of symbol sequences. In some examples, the second element of the composition determined in the second iteration corresponds to a same quantity of occurrences of the second symbol of the alphabet of symbols within each symbol sequence of the second subset of symbol sequences.

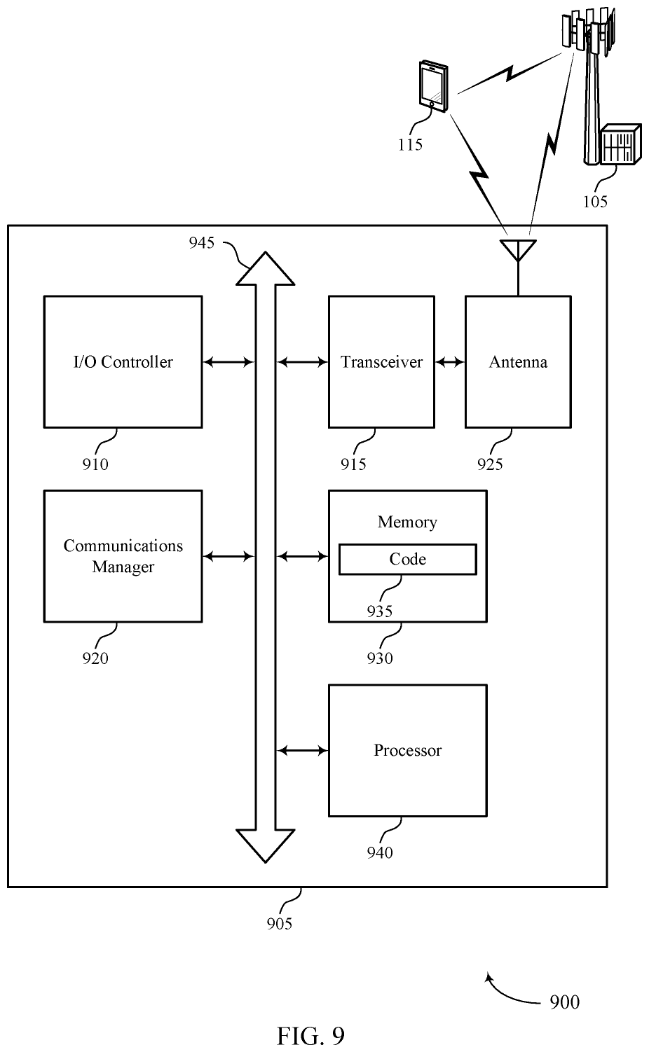

FIG. 9 shows a diagram of a system 900 including a device 905 that supports techniques for probabilistic shaping using peeling in accordance with one or more aspects of the present disclosure. The device 905 may be an example of or include the components of a device 605, a device 705, a network entity 105, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for probabilistic shaping using peeling). For example, the device 905 or a component of the device 905 may include a processor 940 and memory 930 coupled with or to the processor 940, the processor 940 and memory 930 configured to perform various functions described herein.

The communications manager 920 may support wireless communication at a first device (e.g., the device 905) in accordance with examples as disclosed herein. For example, the communications manager 920 may be configured as or otherwise support a means for obtaining a set of multiple information bits. The communications manager 920 may be configured as or otherwise support a means for performing a two-stage encoding operation using the set of multiple information bits, the two-stage encoding operation includes determining an interval corresponding to an energy threshold for a set of symbol sequences, each symbol sequence of the set of symbol sequences being of a same length. The two-stage encoding operation also includes determining, in a first stage of the two-stage encoding operation, a composition of a symbol sequence of the set of symbol sequences based on the set of multiple information bits, where a first element of the composition is determined in a first iteration of the first stage of the two-stage encoding operation based on selecting a first transition associated with a first transition probability, the first element of the composition corresponding to a quantity of occurrences of a first symbol of an alphabet of symbols used for generating the symbol sequence, a first subinterval of the interval is determined, the first subinterval corresponding to the first transition, a second element of the composition is determined in a second iteration of the first stage of the two-stage encoding operation based on selecting a second transition associated with a second transition probability, the second element of the composition corresponding to a quantity of occurrences of a second symbol of the alphabet of symbols used for generating the symbol sequence, and a second subinterval of the interval is determined, the second subinterval corresponding to the second transition. The communications manager 920 may be configured as or otherwise support a means for generating, in a second stage of the two-stage encoding operation, the symbol sequence based on the set of multiple information bits and the composition, where an energy of the symbol sequence is less than or equal to the energy threshold. The communications manager 920 may be configured as or otherwise support a means for transmitting the symbol sequence to a second device (e.g., another device 905) using a wireless medium.

By including or configuring the communications manager 920 in accordance with examples as described herein, the device 905 may support techniques for improved communication reliability, reduced latency, improved user experience related to reduced processing, reduced power consumption, improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for probabilistic shaping using peeling as described herein, or the processor 940 and the memory 930 may be otherwise configured to perform or support such operations.

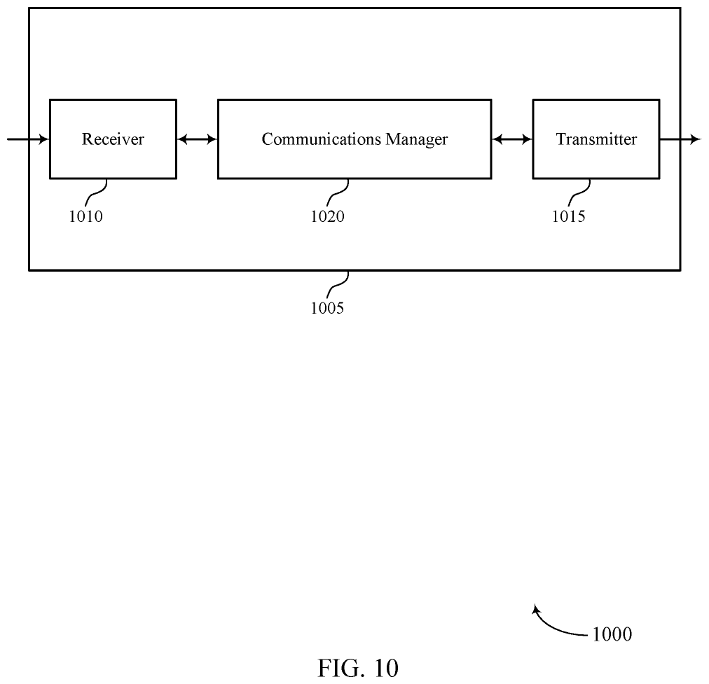

FIG. 10 shows a block diagram 1000 of a device 1005 that supports techniques for probabilistic shaping using peeling in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of techniques for probabilistic shaping using peeling as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a second device (e.g., the device 1005) in accordance with examples as disclosed herein. For example, the communications manager 1020 may be configured as or otherwise support a means for obtaining a symbol sequence from a first device (e.g., another device 1005). The communications manager 1020 may be configured as or otherwise support a means for performing a two-stage decoding operation using the symbol sequence, the two-stage decoding operation includes determining an interval corresponding to an energy threshold for a set of symbol sequences, where the set of symbol sequences includes the symbol sequence, and where each symbol sequence of the set of symbol sequences is of a same length. The communications manager 1020 may be configured as or otherwise support a means for determining, in a first stage of the two-stage decoding operation, a composition of the symbol sequence, where a first element of the composition is determined in a first iteration of the first stage of the two-stage decoding operation based on a first quantity of occurrences of a first symbol of an alphabet of symbols used for generating the symbol sequence, a first subinterval of the interval is determined based on determining the first element of the composition and a first set of multiple transition probabilities, a second element of the composition is determined in a second iteration of the first stage of the two-stage decoding operation based on a second quantity of occurrences of a second symbol of the alphabet of symbols used for generating the symbol sequence, and a second subinterval of the interval is determined based on determining the second element of the composition and a second set of multiple transition probabilities. The communications manager 1020 may be configured as or otherwise support a means for estimating, in a second stage of the two-stage decoding operation, a bit sequence based on the symbol sequence, the composition, and the second subinterval or one or more other subintervals subsequent to the second subinterval.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing and reduced power consumption.

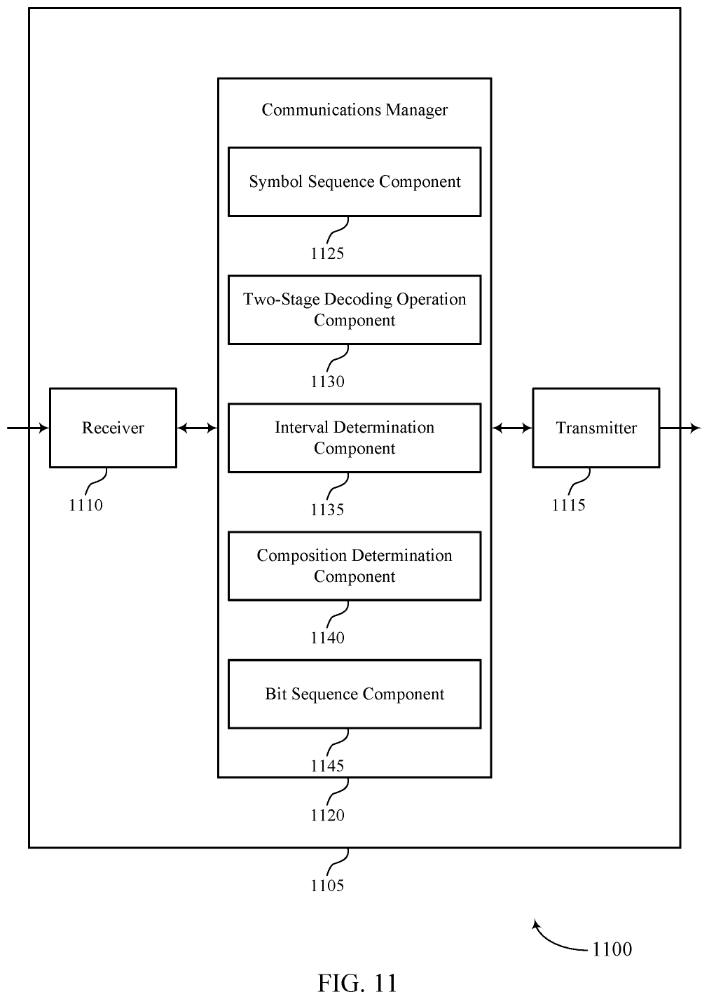

FIG. 11 shows a block diagram 1100 of a device 1105 that supports techniques for probabilistic shaping using peeling in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for probabilistic shaping using peeling as described herein. For example, the communications manager 1120 may include a symbol sequence component 1125, a two-stage decoding operation component 1130, an interval determination component 1135, a composition determination component 1140, a bit sequence component 1145, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a second device (e.g., the device 1105) in accordance with examples as disclosed herein. The symbol sequence component 1125 may be configured as or otherwise support a means for obtaining a symbol sequence from a first device (e.g., another device 1105). The two-stage decoding operation component 1130 may be configured as or otherwise support a means for performing a two-stage decoding operation using the symbol sequence, the two-stage decoding operation includes determining an interval corresponding to an energy threshold for a set of symbol sequences, where the set of symbol sequences includes the symbol sequence, and where each symbol sequence of the set of symbol sequences is of a same length. The composition determination component 1140 may be configured as or otherwise support a means for determining, in a first stage of the two-stage decoding operation, a composition of the symbol sequence, where a first element of the composition is determined in a first iteration of the first stage of the two-stage decoding operation based on a first quantity of occurrences of a first symbol of an alphabet of symbols used for generating the symbol sequence, a first subinterval of the interval is determined based on determining the first element of the composition and a first set of multiple transition probabilities, a second element of the composition is determined in a second iteration of the first stage of the two-stage decoding operation based on a second quantity of occurrences of a second symbol of the alphabet of symbols used for generating the symbol sequence, and a second subinterval of the interval is determined based on determining the second element of the composition and a second set of multiple transition probabilities. The bit sequence component 1145 may be configured as or otherwise support a means for estimating, in a second stage of the two-stage decoding operation, a bit sequence based on the symbol sequence, the composition, and the second subinterval or one or more other subintervals subsequent to the second subinterval.

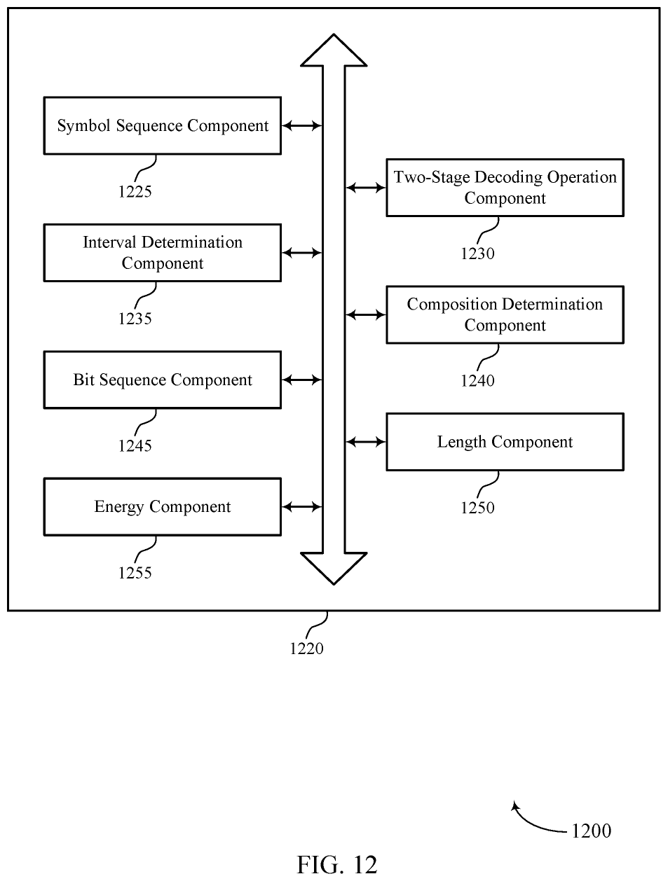

FIG. 12 shows a block diagram 1200 of a communications manager 1220 that supports techniques for probabilistic shaping using peeling in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for probabilistic shaping using peeling as described herein. For example, the communications manager 1220 may include a symbol sequence component 1225, a two-stage decoding operation component 1230, an interval determination component 1235, a composition determination component 1240, a bit sequence component 1245, a length component 1250, an energy component 1255, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a second device (e.g., a UE, a network entity) in accordance with examples as disclosed herein. The symbol sequence component 1225 may be configured as or otherwise support a means for obtaining a symbol sequence from a first device (e.g., another UE, another network entity). The two-stage decoding operation component 1230 may be configured as or otherwise support a means for performing a two-stage decoding operation using the symbol sequence, the two-stage decoding operation includes determining an interval corresponding to an energy threshold for a set of symbol sequences, where the set of symbol sequences includes the symbol sequence, and where each symbol sequence of the set of symbol sequences is of a same length. The composition determination component 1240 may be configured as or otherwise support a means for determining, in a first stage of the two-stage decoding operation, a composition of the symbol sequence, where a first element of the composition is determined in a first iteration of the first stage of the two-stage decoding operation based on a first quantity of occurrences of a first symbol of an alphabet of symbols used for generating the symbol sequence, a first subinterval of the interval is determined based on determining the first element of the composition and a first set of multiple transition probabilities, a second element of the composition is determined in a second iteration of the first stage of the two-stage decoding operation based on a second quantity of occurrences of a second symbol of the alphabet of symbols used for generating the symbol sequence, and a second subinterval of the interval is determined based on determining the second element of the composition and a second set of multiple transition probabilities. The bit sequence component 1245 may be configured as or otherwise support a means for estimating, in a second stage of the two-stage decoding operation, a bit sequence based on the symbol sequence, the composition, and the second subinterval or one or more other subintervals subsequent to the second subinterval.

In some examples, to support determining the composition of the symbol sequence, the composition determination component 1240 may be configured as or otherwise support a means for identifying a first set of nonnegative integers, where each integer of the first set of nonnegative integers is less than or equal to the first element of the composition. In some examples, to support determining the composition of the symbol sequence, the composition determination component 1240 may be configured as or otherwise support a means for determining a first set of multiple cumulative sequence quantities, where a first cumulative sequence quantity of the first set of multiple cumulative sequence quantities corresponds to a first cardinality of a respective first set of sequences of a first set of multiple sets of sequences generated using a first portion of the alphabet of symbol sequences, a first length of each sequence of the respective first set of sequences of the first set of multiple sets of sequences corresponds to a first difference between a length of the symbol sequence and a first nonnegative integer of the first set of nonnegative integers, and a first energy of each sequence of the respective first set of sequences of the first set of multiple sets of sequences is less than or equal to a second difference between the energy threshold and a product of the first nonnegative integer of the first set of nonnegative integers and an energy of the first symbol. In some examples, to support determining the composition of the symbol sequence, the composition determination component 1240 may be configured as or otherwise support a means for determining a first set of multiple binomial coefficients. In some examples, to support determining the composition of the symbol sequence, the composition determination component 1240 may be configured as or otherwise support a means for determining the first set of multiple transition probabilities based at least on the first set of multiple cumulative sequence quantities and the first set of multiple binomial coefficients.

In some examples, each transition probability of the first set of multiple transition probabilities corresponds to a respective nonnegative integer of the first set of nonnegative integers. In some examples, the first set of nonnegative integers includes the first element. In some examples, a length of the first subinterval is proportional to a transition probability corresponding to the first element of the composition.

In some examples, the length component 1250 may be configured as or otherwise support a means for determining a residual length, the residual length being equal to a difference between the length of the symbol sequence and the first element of the composition. In some examples, the energy component 1255 may be configured as or otherwise support a means for determining a residual energy, the residual energy being equal to a difference between the energy threshold and a product of the first element of the composition and the energy of the first symbol.

In some examples, the composition determination component 1240 may be configured as or otherwise support a means for identifying a second set of nonnegative integers, where each nonnegative integer of the second set of nonnegative integers is less than or equal to the second element of the composition. In some examples, the composition determination component 1240 may be configured as or otherwise support a means for determining a second set of multiple cumulative sequence quantities, where a second cumulative sequence quantity of the second set of multiple cumulative sequence quantities corresponds to a second cardinality of a respective second set of sequences of a second set of multiple sets of sequences generated using a second portion of the alphabet of symbols, a second length of each sequence of the respective second set of sequences of the second set of multiple sets of sequences corresponds to a third difference between the residual length and a second nonnegative integer of the second set of nonnegative integers, and a second energy of each sequence of the respective second set of sequences of the second set of multiple sets of sequences is less than or equal to a fourth difference between the residual energy and a product of the second nonnegative integer and an energy of the second symbol. In some examples, the composition determination component 1240 may be configured as or otherwise support a means for determining a second set of multiple binomial coefficients. In some examples, the composition determination component 1240 may be configured as or otherwise support a means for determining the second set of multiple transition probabilities based at least on the second set of multiple cumulative sequence quantities and the second set of multiple binomial coefficients.

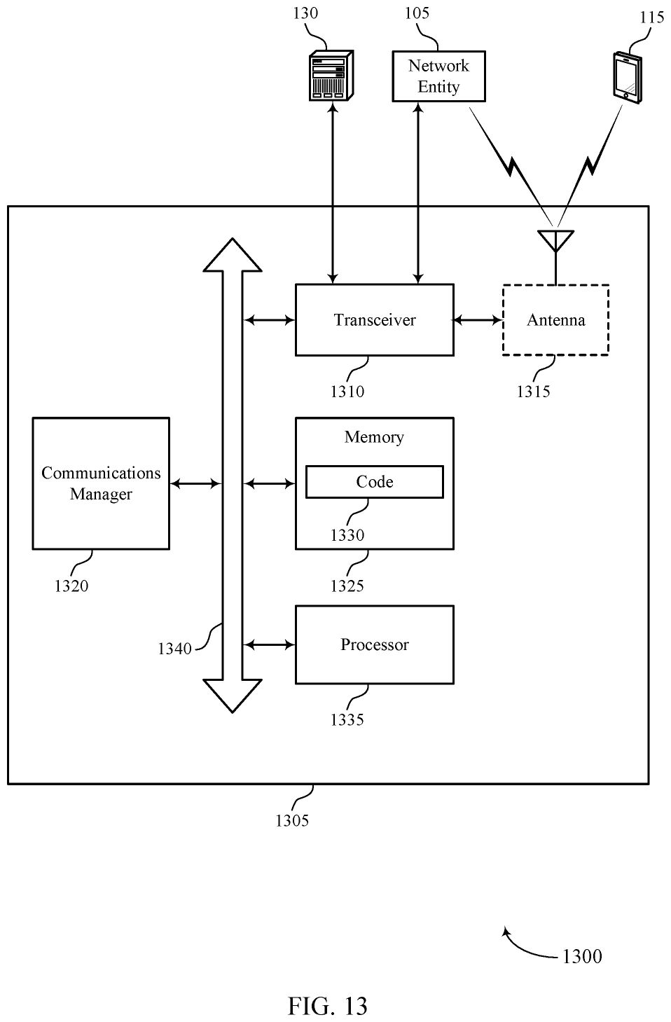

FIG. 13 shows a diagram of a system 1300 including a device 1305 that supports techniques for probabilistic shaping using peeling in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting techniques for probabilistic shaping using peeling). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and an interface to output information, or to obtain information, or both. The interface may be implemented as or otherwise include a first interface configured to output information and a second interface configured to obtain information. In some implementations, the first interface may refer to an interface between the processing system of the chip or modem and a transmitter, such that the device 1305 may transmit information output from the chip or modem. In some implementations, the second interface may refer to an interface between the processing system of the chip or modem and a receiver, such that the device 1305 may obtain information or signal inputs, and the information may be passed to the processing system. A person having ordinary skill in the art will readily recognize that the first interface also may obtain information or signal inputs, and the second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a second device (e.g., the device 1305) in accordance with examples as disclosed herein. For example, the communications manager 1320 may be configured as or otherwise support a means for obtaining a symbol sequence from a first device (e.g., another device 1305). The communications manager 1320 may be configured as or otherwise support a means for performing a two-stage decoding operation using the symbol sequence, the two-stage decoding operation includes determining an interval corresponding to an energy threshold for a set of symbol sequences, where the set of symbol sequences includes the symbol sequence, and where each symbol sequence of the set of symbol sequences is of a same length. The communications manager 1320 may be configured as or otherwise support a means for determining, in a first stage of the two-stage decoding operation, a composition of the symbol sequence, where a first element of the composition is determined in a first iteration of the first stage of the two-stage decoding operation based on a first quantity of occurrences of a first symbol of an alphabet of symbols used for generating the symbol sequence, a first subinterval of the interval is determined based on determining the first element of the composition and a first set of multiple transition probabilities, a second element of the composition is determined in a second iteration of the first stage of the two-stage decoding operation based on a second quantity of occurrences of a second symbol of the alphabet of symbols used for generating the symbol sequence, and a second subinterval of the interval is determined based on determining the second element of the composition and a second set of multiple transition probabilities. The communications manager 1320 may be configured as or otherwise support a means for estimating, in a second stage of the two-stage decoding operation, a bit sequence based on the symbol sequence, the composition, and the second subinterval or one or more other subintervals subsequent to the second subinterval.

By including or configuring the communications manager 1320 in accordance with examples as described herein, the device 1305 may support techniques for improved communication reliability, reduced latency, improved user experience related to reduced processing, reduced power consumption, and improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of techniques for probabilistic shaping using peeling as described herein, or the processor 1335 and the memory 1325 may be otherwise configured to perform or support such operations.

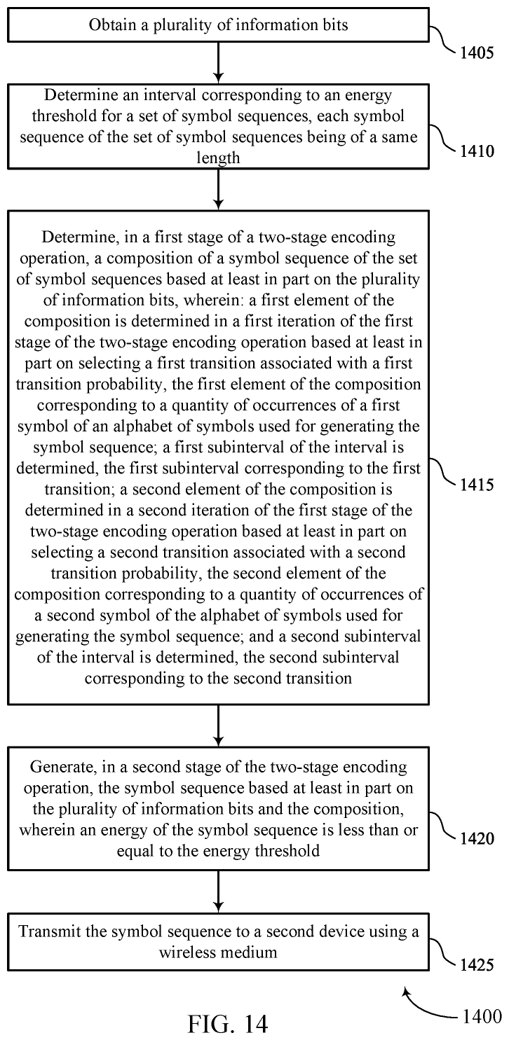

FIG. 14 shows a flowchart illustrating a method 1400 that supports techniques for probabilistic shaping using peeling in accordance with one or more aspects of the present disclosure. The operations of the method 1400 may be implemented by a UE or a network entity or respective components of a UE or a network entity as described herein. For example, the operations of the method 1400 may be performed by a device (e.g., UE 115 or a network entity 105) as described with reference to FIGS. 1 through 9. In some examples, a device may execute a set of instructions to control the functional elements of the device to perform the described functions. Additionally, or alternatively, the device may perform aspects of the described functions using special-purpose hardware.

At 1405, the method may include obtaining a set of multiple information bits. The operations of 1405 may be performed in accordance with examples as disclosed herein. In some examples, aspects of the operations of 1405 may be performed by an information bit component 825 as described with reference to FIG. 8.

At 1410, the method may include determining an interval corresponding to an energy threshold for a set of symbol sequences, each symbol sequence of the set of symbol sequences being of a same length. The operations of 1410 may be performed in accordance with examples as disclosed herein. In some examples, aspects of the operations of 1410 may be performed by an interval component 835 as described with reference to FIG. 8.

At 1415, the method may include determining, in a first stage of the two-stage encoding operation, a composition of a symbol sequence of the set of symbol sequences based on the set of multiple information bits, where a first element of the composition is determined in a first iteration of the first stage of the two-stage encoding operation based on selecting a first transition associated with a first transition probability, the first element of the composition corresponding to a quantity of occurrences of a first symbol of an alphabet of symbols used for generating the symbol sequence, a first subinterval of the interval is determined, the first subinterval corresponding to the first transition, a second element of the composition is determined in a second iteration of the first stage of the two-stage encoding operation based on selecting a second transition associated with a second transition probability, the second element of the composition corresponding to a quantity of occurrences of a second symbol of the alphabet of symbols used for generating the symbol sequence, and a second subinterval of the interval is determined, the second subinterval corresponding to the second transition. The operations of 1415 may be performed in accordance with examples as disclosed herein. In some examples, aspects of the operations of 1415 may be performed by a composition component 840 as described with reference to FIG. 8.

At 1420, the method may include generating, in a second stage of the two-stage encoding operation, the symbol sequence based on the set of multiple information bits and the composition, where an energy of the symbol sequence is less than or equal to the energy threshold. The operations of 1420 may be performed in accordance with examples as disclosed herein. In some examples, aspects of the operations of 1420 may be performed by a sequence component 845 as described with reference to FIG. 8.

At 1425, the method may include transmitting the symbol sequence to a second device using a wireless medium. The operations of 1425 may be performed in accordance with examples as disclosed herein. In some examples, aspects of the operations of 1425 may be performed by a sequence component 845 as described with reference to FIG. 8.

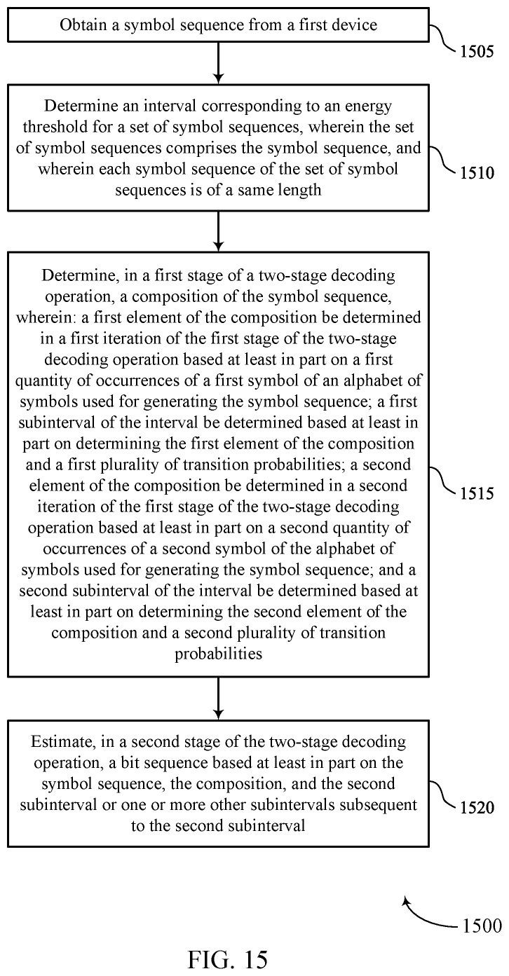

FIG. 15 shows a flowchart illustrating a method 1500 that supports techniques for probabilistic shaping using peeling in accordance with one or more aspects of the present disclosure. The operations of the method 1500 may be implemented by a network entity or a UE or respective components of a network entity or a UE as described herein. For example, the operations of the method 1500 may be performed by device (e.g., a network entity or a UE) as described with reference to FIGS. 1 through 3 and 10 through 13. In some examples, a device may execute a set of instructions to control the functional elements of the network entity to perform the described functions. Additionally, or alternatively, the device may perform aspects of the described functions using special-purpose hardware.

At 1505, the method may include obtaining a symbol sequence from a first device. The operations of 1505 may be performed in accordance with examples as disclosed herein. In some examples, aspects of the operations of 1505 may be performed by a symbol sequence component 1225 as described with reference to FIG. 12.

At 1510, the method may include determining an interval corresponding to an energy threshold for a set of symbol sequences, where the set of symbol sequences includes the symbol sequence, and where each symbol sequence of the set of symbol sequences is of a same length. The operations of 1510 may be performed in accordance with examples as disclosed herein. In some examples, aspects of the operations of 1510 may be performed by an interval determination component 1235 as described with reference to FIG. 12.

At 1515, the method may include determining, in a first stage of the two-stage decoding operation, a composition of the symbol sequence, where include a first element of the composition is determined in a first iteration of the first stage of the two-stage decoding operation based on a first quantity of occurrences of a first symbol of an alphabet of symbols used for generating the symbol sequence, a first subinterval of the interval is determined based on determining the first element of the composition and a first set of multiple transition probabilities, a second element of the composition is determined in a second iteration of the first stage of the two-stage decoding operation based on a second quantity of occurrences of a second symbol of the alphabet of symbols used for generating the symbol sequence, and a second subinterval of the interval is determined based on determining the second element of the composition and a second set of multiple transition probabilities. The operations of 1515 may be performed in accordance with examples as disclosed herein. In some examples, aspects of the operations of 1515 may be performed by a composition determination component 1240 as described with reference to FIG. 12.

At 1520, the method may include estimating, in a second stage of the two-stage decoding operation, a bit sequence based on the symbol sequence, the composition, and the second subinterval or one or more other subintervals subsequent to the second subinterval. The operations of 1520 may be performed in accordance with examples as disclosed herein. In some examples, aspects of the operations of 1520 may be performed by a bit sequence component 1245 as described with reference to FIG. 12.

The following provides an overview of aspects of the present disclosure:

Aspect 1: A method for wireless communication at a first device, comprising: obtaining a plurality of information bits; performing a two-stage encoding operation using the plurality of information bits, the two-stage encoding operation comprising: determining an interval corresponding to an energy threshold for a set of symbol sequences, each symbol sequence of the set of symbol sequences being of a same length; determining, in a first stage of the two-stage encoding operation, a composition of a symbol sequence of the set of symbol sequences based at least in part on the plurality of information bits, wherein: a first element of the composition is determined in a first iteration of the first stage of the two-stage encoding operation based at least in part on selecting a first transition associated with a first transition probability, the first element of the composition corresponding to a quantity of occurrences of a first symbol of an alphabet of symbols used for generating the symbol sequence, a first subinterval of the interval is determined, the first subinterval corresponding to the first transition, a second element of the composition is determined in a second iteration of the first stage of the two-stage encoding operation based at least in part on selecting a second transition associated with a second transition probability, the second element of the composition corresponding to a quantity of occurrences of a second symbol of the alphabet of symbols used for generating the symbol sequence, and a second subinterval of the interval is determined, the second subinterval corresponding to the second transition; generating, in a second stage of the two-stage encoding operation, the symbol sequence based at least in part on the plurality of information bits and the composition, wherein an energy of the symbol sequence is less than or equal to the energy threshold; and transmitting the symbol sequence to a second device using a wireless medium.

Aspect 2: The method of aspect 1, wherein determining the composition of the symbol sequence further comprises: determining a first number based at least in part on the plurality of information bits and the energy threshold; identifying a first set of nonnegative integers, wherein each integer comprises a first candidate element associated with the first element of the composition; determining a first plurality of cumulative sequence quantities, wherein: a first cumulative sequence quantity of the first plurality of cumulative sequence quantities corresponds to a first cardinality of a respective first set of sequences of a first plurality of sets of sequences generated using a first portion of the alphabet of symbols, a first length of each sequence of the respective first set of sequences of the first plurality of sets of sequences corresponds to a first difference between a length of the symbol sequence and a first nonnegative integer of the first set of nonnegative integers, and a first energy of each sequence of the respective first set of sequences of the first plurality of sets of sequences is less than or equal to a second difference between the energy threshold and a product of the first nonnegative integer of the first set of nonnegative integers and an energy of the first symbol; determining a first plurality of binomial coefficients; determining a first plurality of transition probabilities based at least on the first plurality of cumulative sequence quantities and the first plurality of binomial coefficients; identifying that the first number corresponds to the first transition probability from the first plurality of transition probabilities, wherein determining the first element of the composition is based at least in part on the identifying; and performing a first scaling operation on the first number based at least in part on determining the first element of the composition and the first plurality of transition probabilities, wherein a second number is generated based at least in part on the first scaling operation.

Aspect 3: The method of aspect 2, further comprising: determining a residual length, the residual length being equal to a difference between the length of the symbol sequence and the first element of the composition; and determining a residual energy, the residual energy being equal to a difference between the energy threshold and a product of the first element of the composition and the energy of the first symbol.

Aspect 4: The method of aspect 3, further comprising: identifying a second set of nonnegative integers, wherein each nonnegative integer of the second set of nonnegative integers comprises a second candidate element associated with the second element of the composition; determining a second plurality of cumulative sequence quantities, wherein: a second cumulative sequence quantity of the second plurality of cumulative sequence quantities corresponds to a second cardinality of a respective second set of sequences of a second plurality of sets of sequences generated using a second portion of the alphabet of symbol sequences, a second length of each sequence of the respective second set of sequences of the second plurality of sets of sequences corresponds to a third difference between the residual length and a second nonnegative integer of the second set of nonnegative integers, and a second energy of each sequence of the respective second set of sequences of the second plurality of sets of sequences is less than or equal to a fourth difference between the residual energy and a product of the second nonnegative integer and an energy of the second symbol; determining a second plurality of binomial coefficients; determining a second plurality of transition probabilities based at least on the second plurality of cumulative sequence quantities and the second plurality of binomial coefficients; and identifying that the second number corresponds to the second transition probability from the second plurality of transition probabilities, wherein determining the second element of the composition is based at least in part on the identifying; and performing a second scaling operation on the second number based at least in part on determining the second element of the composition and the second plurality of transition probabilities, wherein a third number is generated based at least in part on the second scaling operation.

Aspect 5: The method of aspect 4, wherein each transition probability of the second plurality of transition probabilities corresponds to a respective nonnegative integer of the second set of nonnegative integers, and the second plurality of transition probabilities comprises a first quantity of transition probabilities equal to a second quantity of nonnegative integers included in the second set of nonnegative integers.

Aspect 6: The method of any of aspects 2 through 5, wherein each transition probability of the first plurality of transition probabilities corresponds to a respective nonnegative integer of the first set of nonnegative integers, and the first plurality of transition probabilities comprises a first quantity of transition probabilities equal to a second quantity of nonnegative integers included in the first set of nonnegative integers.

Aspect 7: The method of any of aspects 2 through 6, further comprising: partitioning the interval into a first plurality of subintervals in the first iteration of the first stage of the two-stage encoding operation based at least in part on the first plurality of transition probabilities, wherein a respective length of each subinterval of the first plurality of subintervals is proportional to a respective transition probability of the first plurality of transition probabilities; identifying the first subinterval based at least in part on the first number and the first plurality of subintervals; and performing a scaling operation on the first subinterval based at least in part on the identifying.

Aspect 8: The method of aspect 7, further comprising: partitioning the first subinterval in the second iteration of the first stage of the two-stage encoding operation into a second plurality of subintervals, wherein a respective length of each subinterval of the second plurality of subintervals is proportional to a respective transition probability of a second plurality of transition probabilities; and identifying the second subinterval based at least in part on the second number and the second plurality of subintervals.

Aspect 9: The method of any of aspects 1 through 8, wherein the two-stage encoding operation comprises amplitude shaping, and the first symbol and the second symbol each comprise an amplitude symbol.

Aspect 10: The method of any of aspects 1 through 9, wherein the first stage comprises a plurality of iterations including at least the first iteration and the second iteration, and the plurality of iterations is based at least in part on a cardinality of the alphabet.

Aspect 11: The method of any of aspects 1 through 10, wherein the composition comprises a plurality of elements including at least the first element and the second element, and the plurality of elements is based at least in part on a cardinality of the alphabet.

Aspect 12: The method of aspect 11, wherein each element of the plurality of elements comprises a nonnegative integer.

Aspect 13: The method of any of aspects 1 through 12, wherein the first subinterval corresponds to a first subset of symbol sequences of the set of symbol sequences and the second subinterval corresponds to a second subset of symbol sequences of the first subset of symbol sequences.

Aspect 14: The method of aspect 13, wherein the first element of the composition determined in the first iteration corresponds to a same quantity of occurrences of the first symbol of the alphabet of symbols within each symbol sequence of the first subset of symbol sequences, and the second element of the composition determined in the second iteration corresponds to a same quantity of occurrences of the second symbol of the alphabet of symbols within each symbol sequence of the second subset of symbol sequences.

Aspect 15: A method for wireless communication at a second device, comprising: obtaining a symbol sequence from a first device; performing a two-stage decoding operation using the symbol sequence, the two-stage decoding operation comprising: determining an interval corresponding to an energy threshold for a set of symbol sequences, wherein the set of symbol sequences comprises the symbol sequence, and wherein each symbol sequence of the set of symbol sequences is of a same length; determining, in a first stage of the two-stage decoding operation, a composition of the symbol sequence, wherein: a first element of the composition is determined in a first iteration of the first stage of the two-stage decoding operation based at least in part on a first quantity of occurrences of a first symbol of an alphabet of symbols used for generating the symbol sequence, a first subinterval of the interval is determined based at least in part on determining the first element of the composition and a first plurality of transition probabilities, a second element of the composition is determined in a second iteration of the first stage of the two-stage decoding operation based at least in part on a second quantity of occurrences of a second symbol of the alphabet of symbols used for generating the symbol sequence, and a second subinterval of the interval is determined based at least in part on determining the second element of the composition and a second plurality of transition probabilities; and estimating, in a second stage of the two-stage decoding operation, a bit sequence based at least in part on the symbol sequence, the composition, and the second subinterval or one or more other subintervals subsequent to the second subinterval.

Aspect 16: The method of aspect 15, wherein determining the composition of the symbol sequence further comprises: identifying a first set of nonnegative integers, wherein each integer of the first set of nonnegative integers is less than or equal to the first element of the composition; determining a first plurality of cumulative sequence quantities, wherein: a first cumulative sequence quantity of the first plurality of cumulative sequence quantities corresponds to a first cardinality of a respective first set of sequences of a first plurality of sets of sequences generated using a first portion of the alphabet of symbol sequences, a first length of each sequence of the respective first set of sequences of the first plurality of sets of sequences corresponds to a first difference between a length of the symbol sequence and a first nonnegative integer of the first set of nonnegative integers, and a first energy of each sequence of the respective first set of sequences of the first plurality of sets of sequences is less than or equal to a second difference between the energy threshold and a product of the first nonnegative integer of the first set of nonnegative integers and an energy of the first symbol; determining a first plurality of binomial coefficients; and determining the first plurality of transition probabilities based at least on the first plurality of cumulative sequence quantities and the first plurality of binomial coefficients.

Aspect 17: The method of aspect 16, wherein each transition probability of the first plurality of transition probabilities corresponds to a respective nonnegative integer of the first set of nonnegative integers.

Aspect 18: The method of aspect 17, wherein the first set of nonnegative integers comprises the first element, and a length of the first subinterval is proportional to a transition probability corresponding to the first element of the composition.

Aspect 19: The method of any of aspects 17 through 18, further comprising: determining a residual length, the residual length being equal to a difference between the length of the symbol sequence and the first element of the composition; and determining a residual energy, the residual energy being equal to a difference between the energy threshold and a product of the first element of the composition and the energy of the first symbol.

Aspect 20: The method of aspect 19, further comprising: identifying a second set of nonnegative integers, wherein each nonnegative integer of the second set of nonnegative integers is less than or equal to the second element of the composition; determining a second plurality of cumulative sequence quantities, wherein: a second cumulative sequence quantity of the second plurality of cumulative sequence quantities corresponds to a second cardinality of a respective second set of sequences of a second plurality of sets of sequences generated using a second portion of the alphabet of symbols, a second length of each sequence of the respective second set of sequences of the second plurality of sets of sequences corresponds to a third difference between the residual length and a second nonnegative integer of the second set of nonnegative integers, and a second energy of each sequence of the respective second set of sequences of the second plurality of sets of sequences is less than or equal to a fourth difference between the residual energy and a product of the second nonnegative integer and an energy of the second symbol; determining a second plurality of binomial coefficients; and determining the second plurality of transition probabilities based at least on the second plurality of cumulative sequence quantities and the second plurality of binomial coefficients.

Aspect 21: An apparatus for wireless communication at a first device, comprising a processor; memory coupled with the processor; and instructions stored in the memory and executable by the processor to cause the apparatus to perform a method of any of aspects 1 through 14.

Aspect 22: An apparatus for wireless communication at a first device, comprising at least one means for performing a method of any of aspects 1 through 14.

Aspect 23: A non-transitory computer-readable medium storing code for wireless communication at a first device, the code comprising instructions executable by a processor to perform a method of any of aspects 1 through 14.

Aspect 24: An apparatus for wireless communication at a second device, comprising a processor; memory coupled with the processor; and instructions stored in the memory and executable by the processor to cause the apparatus to perform a method of any of aspects 15 through 20.

Aspect 25: An apparatus for wireless communication at a second device, comprising at least one means for performing a method of any of aspects 15 through 20.

Aspect 26: A non-transitory computer-readable medium storing code for wireless communication at a second device, the code comprising instructions executable by a processor to perform a method of any of aspects 15 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first device, comprising:
obtaining a plurality of information bits;
performing a two-stage encoding operation using the plurality of information bits, the two-stage encoding operation comprising:
determining an interval corresponding to an energy threshold for a set of symbol sequences, each symbol sequence of the set of symbol sequences being of a same length:
determining, in a first stage of the two-stage encoding operation, a composition of a symbol sequence of the set of symbol sequences based at least in part on the plurality of information bits, wherein:
a first element of the composition is determined in a first iteration of the first stage of the two-stage encoding operation based at least in part on selecting a first transition associated with a first transition probability, the first element of the composition corresponding to a quantity of occurrences of a first symbol of an alphabet of symbols used for generating the symbol sequence,
a first subinterval of the interval is determined, the first subinterval corresponding to the first transition,
a second element of the composition is determined in a second iteration of the first stage of the two-stage encoding operation based at least in part on selecting a second transition associated with a second transition probability, the second element of the composition corresponding to a quantity of occurrences of a second symbol of the alphabet of symbols used for generating the symbol sequence, and
a second subinterval of the interval is determined, the second subinterval corresponding to the second transition; and
generating, in a second stage of the two-stage encoding operation, the symbol sequence based at least in part on the plurality of information bits and the composition, wherein an energy of the symbol sequence is less than or equal to the energy threshold; and
transmitting the symbol sequence to a second device using a wireless medium.

2. The method of claim 1, wherein determining the composition of the symbol sequence further comprises:
determining a first number based at least in part on the plurality of information bits and the energy threshold:
identifying a first set of nonnegative integers, wherein each integer comprises a first candidate element associated with the first element of the composition:
determining a first plurality of cumulative sequence quantities, wherein:
a first cumulative sequence quantity of the first plurality of cumulative sequence quantities corresponds to a first cardinality of a respective first set of sequences of a first plurality of sets of sequences generated using a first portion of the alphabet of symbols,
a first length of each sequence of the respective first set of sequences of the first plurality of sets of sequences corresponds to a first difference between a length of the symbol sequence and a first nonnegative integer of the first set of nonnegative integers, and
a first energy of each sequence of the respective first set of sequences of the first plurality of sets of sequences is less than or equal to a second difference between the energy threshold and a product of the first nonnegative integer of the first set of nonnegative integers and an energy of the first symbol:
determining a first plurality of binomial coefficients;
determining a first plurality of transition probabilities based at least on the first plurality of cumulative sequence quantities and the first plurality of binomial coefficients:
identifying that the first number corresponds to the first transition probability from the first plurality of transition probabilities, wherein determining the first element of the composition is based at least in part on the identifying; and
performing a first scaling operation on the first number based at least in part on determining the first element of the composition and the first plurality of transition probabilities, wherein a second number is generated based at least in part on the first scaling operation.

3. The method of claim 2, further comprising:
determining a residual length, the residual length being equal to a difference between the length of the symbol sequence and the first element of the composition; and
determining a residual energy, the residual energy being equal to a difference between the energy threshold and a product of the first element of the composition and the energy of the first symbol.

4. The method of claim 3, further comprising:
identifying a second set of nonnegative integers, wherein each nonnegative integer of the second set of nonnegative integers comprises a second candidate element associated with the second element of the composition:
determining a second plurality of cumulative sequence quantities, wherein:
a second cumulative sequence quantity of the second plurality of cumulative sequence quantities corresponds to a second cardinality of a respective second set of sequences of a second plurality of sets of sequences generated using a second portion of the alphabet of symbol sequences,
a second length of each sequence of the respective second set of sequences of the second plurality of sets of sequences corresponds to a third difference between the residual length and a second nonnegative integer of the second set of nonnegative integers, and
a second energy of each sequence of the respective second set of sequences of the second plurality of sets of sequences is less than or equal to a fourth difference between the residual energy and a product of the second nonnegative integer and an energy of the second symbol:
determining a second plurality of binomial coefficients:
determining a second plurality of transition probabilities based at least on the second plurality of cumulative sequence quantities and the second plurality of binomial coefficients:
identifying that the second number corresponds to the second transition probability from the second plurality of transition probabilities, wherein determining the second element of the composition is based at least in part on the identifying; and
performing a second scaling operation on the second number based at least in part on determining the second element of the composition and the second plurality of transition probabilities, wherein a third number is generated based at least in part on the second scaling operation.

5. The method of claim 4, wherein each transition probability of the second plurality of transition probabilities corresponds to a respective nonnegative integer of the second set of nonnegative integers, and the second plurality of transition probabilities comprises a first quantity of transition probabilities equal to a second quantity of nonnegative integers included in the second set of nonnegative integers.

6. The method of claim 2, wherein each transition probability of the first plurality of transition probabilities corresponds to a respective nonnegative integer of the first set of nonnegative integers, and the first plurality of transition probabilities comprises a first quantity of transition probabilities equal to a second quantity of nonnegative integers included in the first set of nonnegative integers.

7. The method of claim 2, further comprising:
partitioning the interval into a first plurality of subintervals in the first iteration of the first stage of the two-stage encoding operation based at least in part on the first plurality of transition probabilities, wherein a respective length of each subinterval of the first plurality of subintervals is proportional to a respective transition probability of the first plurality of transition probabilities:
identifying the first subinterval based at least in part on the first number and the first plurality of subintervals; and
performing a scaling operation on the first subinterval based at least in part on the identifying.

8. The method of claim 7, further comprising:
partitioning the first subinterval in the second iteration of the first stage of the two-stage encoding operation into a second plurality of subintervals, wherein a respective length of each subinterval of the second plurality of subintervals is proportional to a respective transition probability of a second plurality of transition probabilities; and
identifying the second subinterval based at least in part on the second number and the second plurality of subintervals.

9. The method of claim 1, wherein the two-stage encoding operation comprises amplitude shaping, and the first symbol and the second symbol each comprise an amplitude symbol.

10. The method of claim 1, wherein the first stage comprises a plurality of iterations including at least the first iteration and the second iteration, and the plurality of iterations is based at least in part on a cardinality of the alphabet.

11. The method of claim 1, wherein the composition comprises a plurality of elements including at least the first element and the second element, and the plurality of elements is based at least in part on a cardinality of the alphabet.

12. The method of claim 11, wherein each element of the plurality of elements comprises a nonnegative integer.

13. The method of claim 1, wherein the first subinterval corresponds to a first subset of symbol sequences of the set of symbol sequences and the second subinterval corresponds to a second subset of symbol sequences of the first subset of symbol sequences.

14. The method of claim 13, wherein the first element of the composition determined in the first iteration corresponds to a same quantity of occurrences of the first symbol of the alphabet of symbols within each symbol sequence of the first subset of symbol sequences, and the second element of the composition determined in the second iteration corresponds to a same quantity of occurrences of the second symbol of the alphabet of symbols within each symbol sequence of the second subset of symbol sequences.

15. A method for wireless communication at a second device, comprising:
obtaining a symbol sequence from a first device:
performing a two-stage decoding operation using the symbol sequence, the two-stage decoding operation comprising:
determining an interval corresponding to an energy threshold for a set of symbol sequences, wherein the set of symbol sequences comprises the symbol sequence, and wherein each symbol sequence of the set of symbol sequences is of a same length:
determining, in a first stage of the two-stage decoding operation, a composition of the symbol sequence, wherein:
a first element of the composition is determined in a first iteration of the first stage of the two-stage decoding operation based at least in part on a first quantity of occurrences of a first symbol of an alphabet of symbols used for generating the symbol sequence,
a first subinterval of the interval is determined based at least in part on determining the first element of the composition and a first plurality of transition probabilities,
a second element of the composition is determined in a second iteration of the first stage of the two-stage decoding operation based at least in part on a second quantity of occurrences of a second symbol of the alphabet of symbols used for generating the symbol sequence, and
a second subinterval of the interval is determined based at least in part on determining the second element of the composition and a second plurality of transition probabilities; and
estimating, in a second stage of the two-stage decoding operation, a bit sequence based at least in part on the symbol sequence, the composition, and the second subinterval or one or more other subintervals subsequent to the second subinterval.

16. The method of claim 15, wherein determining the composition of the symbol sequence further comprises:
identifying a first set of nonnegative integers, wherein each integer of the first set of nonnegative integers is less than or equal to the first element of the composition:
determining a first plurality of cumulative sequence quantities, wherein:
a first cumulative sequence quantity of the first plurality of cumulative sequence quantities corresponds to a first cardinality of a respective first set of sequences of a first plurality of sets of sequences generated using a first portion of the alphabet of symbol sequences,
a first length of each sequence of the respective first set of sequences of the first plurality of sets of sequences corresponds to a first difference between a length of the symbol sequence and a first nonnegative integer of the first set of nonnegative integers, and
a first energy of each sequence of the respective first set of sequences of the first plurality of sets of sequences is less than or equal to a second difference between the energy threshold and a product of the first nonnegative integer of the first set of nonnegative integers and an energy of the first symbol:
determining a first plurality of binomial coefficients; and
determining the first plurality of transition probabilities based at least on the first plurality of cumulative sequence quantities and the first plurality of binomial coefficients.

17. The method of claim 16, wherein each transition probability of the first plurality of transition probabilities corresponds to a respective nonnegative integer of the first set of nonnegative integers.

18. The method of claim 17, wherein the first set of nonnegative integers comprises the first element, and a length of the first subinterval is proportional to a transition probability corresponding to the first element of the composition.

19. The method of claim 17, further comprising:
determining a residual length, the residual length being equal to a difference between the length of the symbol sequence and the first element of the composition; and
determining a residual energy, the residual energy being equal to a difference between the energy threshold and a product of the first element of the composition and the energy of the first symbol.

20. The method of claim 19, further comprising:
identifying a second set of nonnegative integers, wherein each nonnegative integer of the second set of nonnegative integers is less than or equal to the second element of the composition:
determining a second plurality of cumulative sequence quantities, wherein:
a second cumulative sequence quantity of the second plurality of cumulative sequence quantities corresponds to a second cardinality of a respective second set of sequences of a second plurality of sets of sequences generated using a second portion of the alphabet of symbols,
a second length of each sequence of the respective second set of sequences of the second plurality of sets of sequences corresponds to a third difference between the residual length and a second nonnegative integer of the second set of nonnegative integers, and
a second energy of each sequence of the respective second set of sequences of the second plurality of sets of sequences is less than or equal to a fourth difference between the residual energy and a product of the second nonnegative integer and an energy of the second symbol;
determining a second plurality of binomial coefficients; and
determining the second plurality of transition probabilities based at least on the second plurality of cumulative sequence quantities and the second plurality of binomial coefficients.

21. An apparatus for wireless communication at a first device, comprising:
a processor:
memory coupled with the processor; and
instructions stored in the memory and executable by the processor to cause the apparatus to:
obtain a plurality of information bits:
perform a two-stage encoding operation using the plurality of information bits, the two-stage encoding operation comprising:
determine an interval corresponding to an energy threshold for a set of symbol sequences, each symbol sequence of the set of symbol sequences being of a same length:
determine, in a first stage of the two-stage encoding operation, a composition of a symbol sequence of the set of symbol sequences based at least in part on the plurality of information bits, wherein:
a first element of the composition is determined in a first iteration of the first stage of the two-stage encoding operation based at least in part on selecting a first transition associated with a first transition probability, the first element of the composition corresponding to a quantity of occurrences of a first symbol of an alphabet of symbols used for generating the symbol sequence,
a first subinterval of the interval is determined, the first subinterval corresponding to the first transition,
a second element of the composition is determined in a second iteration of the first stage of the two-stage encoding operation based at least in part on selecting a second transition associated with a second transition probability, the second element of the composition corresponding to a quantity of occurrences of a second symbol of the alphabet of symbols used for generating the symbol sequence, and
a second subinterval of the interval is determined,
the second subinterval corresponding to the second transition; and
generate, in a second stage of the two-stage encoding operation, the symbol sequence based at least in part on the plurality of information bits and the composition, wherein an energy of the symbol sequence is less than or equal to the energy threshold; and
transmit the symbol sequence to a second device using a wireless medium.

22. The apparatus of claim 21, wherein the instructions to determine the composition of the symbol sequence are further executable by the processor to cause the apparatus to:
determine a first number based at least in part on the plurality of information bits and the energy threshold:
identify a first set of nonnegative integers, wherein each integer comprises a first candidate element associated with the first element of the composition:
determine a first plurality of cumulative sequence quantities, wherein:
a first cumulative sequence quantity of the first plurality of cumulative sequence quantities correspond to a first cardinality of a respective first set of sequences of a first plurality of sets of sequences generated using a first portion of the alphabet of symbols,
a first length of each sequence of the respective first set of sequences of the first plurality of sets of sequences correspond to a first difference between a length of the symbol sequence and a first nonnegative integer of the first set of nonnegative integers, and
a first energy of each sequence of the respective first set of sequences of the first plurality of sets of sequences be less than or equal to a second difference between the energy threshold and a product of the first nonnegative integer of the first set of nonnegative integers and an energy of the first symbol:
determine a first plurality of binomial coefficients:
determine a first plurality of transition probabilities based at least on the first plurality of cumulative sequence quantities and the first plurality of binomial coefficients:
identify that the first number corresponds to the first transition probability from the first plurality of transition probabilities, wherein determining the first element of the composition is based at least in part on the identifying; and
perform a first scaling operation on the first number based at least in part on determining the first element of the composition and the first plurality of transition probabilities, wherein a second number is generated based at least in part on the first scaling operation.

23. The apparatus of claim 22, wherein the instructions are further executable by the processor to cause the apparatus to:
determine a residual length, the residual length being equal to a difference between the length of the symbol sequence and the first element of the composition; and
determine a residual energy, the residual energy being equal to a difference between the energy threshold and a product of the first element of the composition and the energy of the first symbol.

24. The apparatus of claim 23, wherein the instructions are further executable by the processor to cause the apparatus to:
identify a second set of nonnegative integers, wherein each nonnegative integer of the second set of nonnegative integers comprises a second candidate element associated with the second element of the composition:
determine a second plurality of cumulative sequence quantities, wherein:
a second cumulative sequence quantity of the second plurality of cumulative sequence quantities correspond to a second cardinality of a respective second set of sequences of a second plurality of sets of sequences generated using a second portion of the alphabet of symbol sequences,
a second length of each sequence of the respective second set of sequences of the second plurality of sets of sequences correspond to a third difference between the residual length and a second nonnegative integer of the second set of nonnegative integers, and
a second energy of each sequence of the respective second set of sequences of the second plurality of sets of sequences be less than or equal to a fourth difference between the residual energy and a product of the second nonnegative integer and an energy of the second symbol:
determine a second plurality of binomial coefficients;
determine a second plurality of transition probabilities based at least on the second plurality of cumulative sequence quantities and the second plurality of binomial coefficients:
identify that the second number corresponds to the second transition probability from the second plurality of transition probabilities, wherein determining the second element of the composition is based at least in part on the identifying; and
perform a second scaling operation on the second number based at least in part on determining the second element of the composition and the second plurality of transition probabilities, wherein a third number is generated based at least in part on the second scaling operation.

25. An apparatus for wireless communication at a first device, comprising:
means for obtaining a plurality of information bits:
means for performing a two-stage encoding operation using the plurality of information bits, the two-stage encoding operation comprising:
means for determining an interval corresponding to an energy threshold for a set of symbol sequences, each symbol sequence of the set of symbol sequences being of a same length:
means for determining, in a first stage of the two-stage encoding operation, a composition of a symbol sequence of the set of symbol sequences based at least in part on the plurality of information bits, wherein:
a first element of the composition is determined in a first iteration of the first stage of the two-stage encoding operation based at least in part on selecting a first transition associated with a first transition probability, the first element of the composition corresponding to a quantity of occurrences of a first symbol of an alphabet of symbols used for generating the symbol sequence,
a first subinterval of the interval is determined, the first subinterval corresponding to the first transition,
a second element of the composition is determined in a second iteration of the first stage of the two-stage encoding operation based at least in part on selecting a second transition associated with a second transition probability, the second element of the composition corresponding to a quantity of occurrences of a second symbol of the alphabet of symbols used for generating the symbol sequence, and
a second subinterval of the interval is determined, the second subinterval corresponding to the second transition:
means for generating, in a second stage of the two-stage encoding operation, the symbol sequence based at least in part on the plurality of information bits and the composition, wherein an energy of the symbol sequence is less than or equal to the energy threshold; and
means for transmitting the symbol sequence to a second device using a wireless medium.

26. The apparatus of claim 25, wherein the means for determining the composition of the symbol sequence further comprise:
means for determining a first number based at least in part on the plurality of information bits and the energy threshold;
means for identifying a first set of nonnegative integers, wherein each integer comprises a first candidate element associated with the first element of the composition:
means for determining a first plurality of cumulative sequence quantities, wherein:
means for a first cumulative sequence quantity of the first plurality of cumulative sequence quantities corresponds to a first cardinality of a respective first set of sequences of a first plurality of sets of sequences generated using a first portion of the alphabet of symbols,
means for a first length of each sequence of the respective first set of sequences of the first plurality of sets of sequences corresponds to a first difference between a length of the symbol sequence and a first nonnegative integer of the first set of nonnegative integers, and
means for a first energy of each sequence of the respective first set of sequences of the first plurality of sets of sequences is less than or equal to a second difference between the energy threshold and a product of the first nonnegative integer of the first set of nonnegative integers and an energy of the first symbol:
means for determining a first plurality of binomial coefficients:
means for determining a first plurality of transition probabilities based at least on the first plurality of cumulative sequence quantities and the first plurality of binomial coefficients:
means for identifying that the first number corresponds to the first transition probability from the first plurality of transition probabilities, wherein determining the first element of the composition is based at least in part on the identifying; and
means for performing a first scaling operation on the first number based at least in part on determining the first element of the composition and the first plurality of transition probabilities, wherein a second number is generated based at least in part on the first scaling operation.

27. The apparatus of claim 26, further comprising:
means for determining a residual length, the residual length being equal to a difference between the length of the symbol sequence and the first element of the composition; and
means for determining a residual energy, the residual energy being equal to a difference between the energy threshold and a product of the first element of the composition and the energy of the first symbol.

28. The apparatus of claim 27, further comprising:
means for identifying a second set of nonnegative integers, wherein each nonnegative integer of the second set of nonnegative integers comprises a second candidate element associated with the second element of the composition:
means for determining a second plurality of cumulative sequence quantities, wherein:
means for a second cumulative sequence quantity of the second plurality of cumulative sequence quantities corresponds to a second cardinality of a respective second set of sequences of a second plurality of sets of sequences generated using a second portion of the alphabet of symbol sequences,
means for a second length of each sequence of the respective second set of sequences of the second plurality of sets of sequences corresponds to a third difference between the residual length and a second nonnegative integer of the second set of nonnegative integers, and
means for a second energy of each sequence of the respective second set of sequences of the second plurality of sets of sequences is less than or equal to a fourth difference between the residual energy and a product of the second nonnegative integer and an energy of the second symbol;
means for determining a second plurality of binomial coefficients:
means for determining a second plurality of transition probabilities based at least on the second plurality of cumulative sequence quantities and the second plurality of binomial coefficients; and
means for identifying that the second number corresponds to the second transition probability from the second plurality of transition probabilities, wherein determining the second element of the composition is based at least in part on the identifying; and
means for performing a second scaling operation on the second number based at least in part on determining the second element of the composition and the second plurality of transition probabilities, wherein a third number is generated based at least in part on the second scaling operation.

29. The apparatus of claim 28, wherein:
each transition probability of the second plurality of transition probabilities corresponds to a respective nonnegative integer of the second set of nonnegative integers, and
the second plurality of transition probabilities comprises a first quantity of transition probabilities equal to a second quantity of nonnegative integers included in the second set of nonnegative integers.

30. The apparatus of claim 26, further comprising:
means for partitioning the interval into a first plurality of subintervals in the first iteration of the first stage of the two-stage encoding operation based at least in part on the first plurality of transition probabilities, wherein a respective length of each subinterval of the first plurality of subintervals is proportional to a respective transition probability of the first plurality of transition probabilities:
means for identifying the first subinterval based at least in part on the first number and the first plurality of subintervals; and
means for performing a scaling operation on the first subinterval based at least in part on the identifying.
